(19) United States
(12) Patent Application Publication
(10) Pub. No.: US 2024/0368378 A1
(43) Pub. Date: Nov. 7, 2024

(54) PROCESS FOR IMPROVING RESIN PERFORMANCE

(71) Applicant: Borchers GmbH, Langenfeld (DE)

(72) Inventors: Neil John Simpson, Bearsden (GB); Sabrina Nehache, Düsseldorf (DE); Claudia Menzel, Hilden (DE)

(73) Assignee: Borchers GmbH, Langenfeld (DE)

(21) Appl. No.: 18/688,202

(22) PCT Filed: May 2, 2022
(86) PCT No.: PCT/EP2022/061724

§ 371 Date: Feb. 29, 2024

(30) Foreign Application Priority Data
Aug. 30, 2021 (EP) 21193736.2

(51) Int. Cl. C08K 5/37; C08K 5/00; C08K 5/56; C09D 7/63; C09D 11/03; C09D 167/08; C09F 9/00

(52) U.S. Cl. CPC C08K 5/37; C08K 5/0091; C08K 5/56; C09D 7/63; C09D 11/03; C09D 167/08; C09F 9/00

(57) ABSTRACT

The invention pertains generally to a process and resulting product of following the steps of the process involving adding an Iron- or Manganese- or Vanadium- or Copper- in combination with a multidentate ligand to form a metal-ligand complex with a thiol or polythiol to an alkyd resin, said steps performed in any order or the synthesis performed in-situ.

### CROSS-REFERENCE TO RELATED APPLICATIONS

None.

### TECHNICAL FIELD

The invention described herein pertains generally to the use of polythiols to increase the coating hardness and speed of drying for oxidatively curable solvent-based coating compositions, such as alkyd coatings.

Primary paint driers, typically metal carboxylates like cobalt neodecanoate, are used to catalyze the oxidative drying (curing) of alkyd resins. Generally, these driers are complexes based on transition metals. Cobalt driers are the most used drying catalysts as they result in highly cross-linked and hard films. Highly cross-linked and hard films are desirable because they have higher scratch, chemical and corrosion resistance. However, several environmental studies have suggested potential reclassification of cobalt-based alkyd driers as Class 1B carcinogenic materials.

Borchi® Oxy Coat, (synonymous with “BOC” in this application) is a primary drier for alkyds. There are at least three patent families linked to Borchi® Oxy-Coat (i.e. EP2038356, EP2521750, EP2474578) that cover the use of the catalyst in different delivery forms, and variations of the structure, in formulation, for oxidatively cured coatings, inks and composites. It has been shown that Borchi® Oxy-Coat shows faster curing and less yellowing of alkyd films at much lower concentrations than cobalt, and is a non-toxic alternative to cobalt-based driers.

Without being limited to any one theory or mode of operation (See “In-depth study of drying solvent-borne alkyd coatings in presence of Mn—and Fe—based catalysts as cobalt alternatives”, Ö. Gezici-Koç, C. A. A. M. Thomas, M. E. B. Michel, S. J. F. E. Erich, H. P. Huinink, J. Flapper, F. L. Duivenvoorde, L. G. J. van der Ven, O. C. G. Adan., Materials Today Communications, vol. 7, pp 22-31 published 1 Jun. 2016), Borchi® Oxy-Coat is believed to cure in a different way to cobalt-based driers enabling faster crosslinking events throughout the coating, but with less crosslink density, leading to softer coatings. There is a need for improved non-cobalt based driers as alternatives. The lack of hardness impacts the use of Borchi® Oxy-Coat as a cobalt replacement in more demanding applications, such as direct to metal coatings or decorative coatings potentially impacting scratch resistance, corrosion resistance and the ability to stack painted pieces quickly. It is hypothesized that aspects of the BOC curing mechanism can be improved via the use of additional agents. The use of a curing agent is required, that is not required at high dose levels, that is non-toxic, that can cure without additional heat or radiation.

One of the important characteristics sought for in a coating is dry time. For dry time, a low number is desired (i.e., fast drying). Drying time, measured for example using a B. K. drying recorder, comes in 3 stages, (i) set-to-touch (ST), which means the paint no longer flows back after the needle has passed through; tack-free (TF) where tearing of the coating is created by the needle, and (iii) dry-hard (DH), where the coating is no longer marked by the needle—further explained in ASTM method D5895-13. Ideally, they are all as low as possible.

### BACKGROUND OF THE INVENTION

The invention relates to an improved approach to imparting hardness to oxidatively curable solvent-based coating compositions, such as alkyd coatings, using a thiol or a polythiol.

It has been unexpectedly found that small multifunctional thiols are enough to improve the hardness of the coating as well as also improving the rate of cure (i.e., decreasing dry time). Finally, and interestingly, the thiols do not work with cobalt-based driers, in some cases it has been found to be the opposite, thereby serving as at least one indicator of the uniqueness of this invention.

Thiolene chemistry is a growing area of academic research, known in coatings to create new bonds in resins by adding a thiol to a double bond. In general, these reactions can be free-radical (i.e. AIBN), UV or amine-catalysed (see Hoyle, C. E., “Photopolymerization of thiol-enes: Click to the future, American Chemical Society (2007) and Lowe, A. B., “Thiol-ene “click” reactions and recent applications in polymer and materials synthesis: a first update”, Polym. Chem. 5(17) pp, 4820-4870 (2014)).

Thiolene chemistry has found application in coatings, for example (see Bartels, J. W., P. M. Imbesi, J. A. Finlay, C. Fidge, J. Ma, J. E. Seppala, A. M. Nystrom, M. E. MacKay, J. A. Callow, M. E. Callow and K. L. Wooley (2011). “Antibiofouling Hybrid Dendritic Boltorn/Star PEG Thiol-ene Cross—Linked Networks” ACS Appl. Mater. Interfaces 3(6), pp 2118-2129 and see also Hayashi, T., Kazlauciunas and P. D. Thornton (2015), “Dye conjugation to linseed oil by highly-effective thiol-ene coupling and subsequent esterification reactions”, Dyes Pigm., 123, pp. 304-316), as a method to photochemically cure vegetable oils or unsaturated telomeres for coating synthesis (see Simpson, N., M. Takwa, K. Hult, M. Johansson, M. Martinelle and E. Malmström (2008). “Thiol-Functionalized Poly(ω-pentadecalactone) Telechelics for Semicrystalline Polymer Networks.” Macromolecules 41(10): pp 3613-3619 and see also Seker, H. and E. Cakmakci (2020) “Fully bio-based thiol-ene photocured thermosets from isosorbide and tung oil”, J. Polym. Sci. (Hoboken, NJ, U. S.) 58(8): pp 1105-1114).

EP 1048706 (Akzo Nobel) discloses the use of thiols in UV coatings containing oxidatively drying polyunsaturated condensation products of ≥1 fatty acids and/or esters, ≥1 polyols and optionally one or more polycarboxylic acids and/or anhydrides of polycarboxylic acids and optionally other building blocks, and ≥1 photoinitiators. They report that using more thiol improves (reduces) the drying time.

Thiolene chemistry has been used to crosslink alkene-functional branched dendrimers (see “Accelerated Growth of Dendrimers via Thiol-Ene and Esterification Reactions”, Maria I. Montañez, Luis M. Campos. Per Antoni, Yvonne Hed, Marie V. Walter, Brandon T. Krull, Anzar Khan, Anders Hult, Craig J. Hawker, and Michael Malkoch, Macromolecules 2010, 43(14), pp. 6004-6013, to make patterned surfaces for antifouling; self-healing coatings for anti-corrosion requiring UV radiation; or polythioethers that can make self-crosslinkable binders reacting with blocked isocyanates to make a binder for water-based coatings relying on the thiol-allyl reaction during cure. None of these are related directly to alkyd coatings.

US 20200197918A1 by PPG does cite the use of polythiols (10% or more) in a formulation. It teaches the use of the thiol in the presence of an organometallic compound based on i.e., cobalt. However, they also claim a catalyst specifically for the thiolene reaction based on an amine. It appears to be a coating based on a poly‘ene’ and a poly‘thiol’. FeCl₃ is also used in the coating.

Sherwin Williams in WO2019094664A1 teaches blends in some acrylic latex (a PU-modified alkyd from DSM that has free isophorone diisocyanate groups, and a cross-linkable latex to increase hardness) using BOC1101 and Zirconium hydro chem.

### SUMMARY OF THE INVENTION

The present invention is directed to an improved approach to imparting hardness to oxidatively cured coatings, such as alkyd coatings, whilst maintaining good, or even improved drying times, to especially address an issue with catalysts prepared using polydentate amine ligands such as BOC. The invention allows for the use of non-carcinogenic catalysts as a replacement for toxic, hypothetically carcinogenic cobalt catalysts in alkyd costings, by enabling superior performance to the afore mentioned catalysts. It was seen that the hardness of cobalt-based driers cannot be improved by combining them with thiol-based crosslinkers, whilst those based on polydentate ligands can be. When combined in our trials with several resin types and in various formulated systems, a significant improvement in hardness was observed, and improvements in dry time, overcoming issues with the use of BOC, to bring performance beyond that of cobalt.

At least one object of the invention is achieved by formulating an oxidatively cured coating using:
(A) At least one oxidatively cured resin, for example an alkyd resin;
(B) At least one primary drier, such as BOC, Borchi Dragon, or other driers with multidentate amine-based ligands combined or complexed to metal salts of iron, vanadium, manganese or copper;
(C) At least one thiol or polythiol as an additive to an alkyd coating formulation, or co-blended with the primary drier and added to the alkyd coating formulation, added at a concentration of between 0.2 to 10% by weight of the resin content;
(D) The thiol or polythiol having one or more of the following characteristics;
   a) At least 15% thiol group content by weight of the thiol (more preferably at least 25% thiol group content);
   b) A thiol that contains unsaturation (i.e., carbon-carbon double bonds);
   c) A thiol that is up to 10 weight percent thiol on the resin solids;
(E) Optionally, at least one antiskinning agent;
(F) Optionally at least one pigment or dye;
(G) Optionally other additives, such as at least one pigment dispersant or at least one rheology additive; adding at least one antiskinning compound; adding one or more auxiliary driers or secondary driers; adding at least one UV stabilizer; adding at least one dispersant; adding at least one surfactant; adding at least one corrosion-inhibitor; adding at least one filler; adding at least one antistatic agent; adding at least one flame-retardant; adding at least one lubricant; adding at least one antifoaming agent; adding at least one antifouling agent; adding at least one bactericides; adding at least one fungicide; adding at least one algaecide; adding at least one insecticide; adding at least one extender; adding at least one plasticizer; adding at least one antifreezing agent; adding at least one wax; adding at least one thickener; and
(H) Optionally, at least one non-aqueous solvent.

These and other objects of this invention will be evident when viewed in light of detailed description and appended claims.

### DETAILED DESCRIPTION OF THE INVENTION

Whilst progress has been made to replace the use of toxic cobalt in alkyd coatings, cobalt carboxylates are still unparalleled in their ability to provide hard coatings upon curing. BOC, and other catalysts based on transition metal complexes or salts of polydentate nitrogen-donating ligands outperform cobalt for drying times, but still create softer coatings, which prevents the total replacement of cobalt in all coating applications.

The present invention is based upon the surprising finding that the introduction of a thiol or polythiol, in combination with a primary drier comprising a complex of a transition metal ion and a polydentate accelerant ligand into an oxidatively curable solvent-based coating composition serves not only to increase the hardness of the coating significantly, but also the dry time. More surprisingly, this effect is not seen for cobalt carboxylates.

The invention has broad utility in relation to a wide variety of solvent-based coating compositions, which term is to be interpreted broadly herein. Examples of coating compositions include clear or coloured varnishes, primary coats, filling pastes, glazes, primers, direct to metal coatings, emulsions and floor coatings, e.g., linoleum floor coverings. Embodiments of the invention relate to solvent-based paints and inks, particularly paints such as high-specification paints intended for industrial use.

The use of the term “oxidatively curable solvent-based coating compositions” as used herein is thus intended to embrace a wide variety of coloured (e.g., by way of pigment or ink) and non-coloured materials, including oils and binders, which form a continuous coating through the course of oxidative reactions, typically to form cross-linkages and other bond formations. Generically, such coating compositions may be characterized by the presence of typically (poly) unsaturated resins that react to form a solid film on a substrate, the resins being initially present in the oxidatively curable solvent-based coating compositions either as liquids, dissolved in an organic solvent or as solids dispersed in a continuous liquid phase. Reaction to form the desired coating upon curing arises from polymerisation reactions initiated by oxidation. Examples of oxidatively curable coating compositions include alkyd-, acrylate-, urethane-, polybutadiene- and epoxy ester-based resins. Typically, the curable (e.g., alkyd resin) portion of the curable composition will comprise between about 1% by weight and about 90% by weight of the total weight of the oxidatively curable solvent-based coating composition, e.g. between about 20 and about 70% by weight of the total weight of the oxidatively curable solvent-based coating composition.

Alkyd resins are a particularly important member of the class of oxidatively curable coating compositions and are a well-studied class of resin to which the present invention may be applied. Hereinafter, embodiments of the invention are described with reference to the use of alkyd resins, also referred to as alkyd-based resins or alkyd(-based) binders. Whilst these represent particularly significant embodiments of the invention, the invention is not to be so limited. To be clear: the invention is applicable to a wide range of oxidatively curable coating compositions, typically those comprising at least 1 or 2% by weight of an unsaturated compound (e.g., comprising unsaturated (non-aromatic) double or triple carbon-carbon bonds).

As used in this application, where percentages by weight are referred to herein (wt. % or wt % or % w/w), these mean, unless a context clearly dictates to the contrary, percentages by weight with respect to the solid resin resultant from curing, i.e. components of the oxidatively curable solvent-based coating compositions that serve to provide the coating upon curing. With an oxidatively curable alkyd coating composition, therefore, the combined weights of the components of the composition that become, i.e., are incorporated into, the alkyd resin coating, i.e., once cured, are those with respect to which weight percentages herein are based. For example, the composition, either resultant from conducting the method according to the first aspect of the invention, or according to the second aspect of the invention, typically comprises about 0.0001% to about 1% w/w, e.g., about 0.0005% to about 0.5% w/w water, or about 0.01% to about 1% w/w, e.g., about 0.05% to about 0.5% w/w water, based on the components of the composition that, when cured, from the coating.

By oxidatively curable solvent-based compositions is meant herein, consistent with the nomenclature used in the art, compositions that are based on organic (i.e., non-aqueous) solvents. Examples of suitable solvents include aliphatic (including alicyclic and branched) hydrocarbons, such as hexane, heptane, octane, cyclohexane, cycloheptane and isoparaffins; aromatic hydrocarbons such as toluene and xylene; ketones, e.g. methyl ethyl ketone and methyl isobutyl ketone; alcohols, such as isopropyl alcohol, n-butyl alcohol and n-propyl alcohol; glycol monoethers, such as the monoethers of ethylene glycol and diethylene glycol; monoether glycol acetates, such as 2-ethoxyethyl acetate; as well as mixtures thereof. Isomeric variants are included. Thus, the term hexane embraces mixtures of hexanes. According to particular embodiments of the invention, the solvent is a hydrocarbyl (i.e., hydrocarbon) solvent, e.g., an aliphatic hydrocarbyl solvent, e.g. solvents comprising mixtures of hydrocarbons. Examples include white spirit and solvents available under the trademarks Shellsol™c (i.e., High Aromatic White Spirit is a blend with a typical C10-C11 aromatics content of 45%), from Shell Chemicals and Solvesso™ (i.e., CAS-No. 64742-95-6) and Exxsol® (e.g., de-aromatized” aliphatic hydrocarbon solvent, the major components are normal paraffins, isoparaffins and cycloparaffins, the product contains very low levels of aromatic hydrocarbons), from Exxon.

The compositions encompassed by the invention comprise a transition metal drier, which is a complex of a transition metal ion and an accelerant ligand, preferably a polydentate accelerant ligand. Each of these components will be further described herein.

The transition metal ions used in oxidatively curable coating compositions may be provided by any convenient water-soluble metal salt, for example a vanadium, manganese, iron, cobalt, nickel, copper, cerium or lead salt, more typically vanadium, manganese, iron or cerium salt, or salts comprising mixtures of either of the foregoing lists of metal ions. The valency of the metal may range from +2 to +5. Embodiments of the invention comprise manganese-, iron-, copper- and/or vanadium-containing ions. Mixtures of ions may be provided. Where an iron-containing drier is provided, this is usually as an Fe(II) or Fe(III) compound. Where a manganese drier is provided, this is usually as a Mn (II), (III) or (IV) compound; and where a vanadium-containing drier is provided this is usually as a V(II), (III), (IV) or (V) compound and where the copper-containing drier is provided, this is usually as a Cu(I) or Cu(II) compound.

As is known, the facility of the metal drier to catalyse the desired oxidation chemistry of oxidatively curable coating compositions arises from its ability to participate in redox chemistry; the nature of the counteranion is not believed to be of great importance. This may serve to provide a readily water-soluble salt such as a chloride, sulfate or acetate. Others counterions are evident to the skilled person.

In order to enhance the activity of the transition metal ions a so-called accelerating compound, herein the “polydentate accelerant ligand”, is also included. As the language suggests the term polydentate accelerant ligand is a compound capable of coordinating to the transition metal ion by way of more than one donor site within the ligand and serves to accelerate the drying (curing process) of the oxidatively curable coating composition after application.

According to some embodiments of the invention, the polydentate accelerant ligand is a bi-, tri-, tetra-, penta- or hexadentate ligand coordinating through nitrogen and/or oxygen donor atoms. In particular embodiments of the invention, the ligand is a bi-, tri-, tetra-, penta- or hexadentate nitrogen donor ligand, in particular a tri-, tetra-, penta-, or hexadentate nitrogen donor ligand. However, the invention is not so limited.

As used herein the term “nitrogen-donor ligand” or “ligand” or “L” is an organic structure or molecule which will support coordinating nitrogen atoms. In the present invention, said at least one nitrogen-donor ligand is selected from the group comprising tridentate, tetradentate, pentadentate and hexadentate nitrogen donor ligands.

Whenever the term “substituted” is used herein, it is meant to indicate that one or more hydrogens on the atom indicated in the expression using “substituted” is replaced with a selection from the indicated group, provided that the indicated atom's normal valency is not exceeded, and that the substitution results in a chemically stable compound, i.e., a compound that is sufficiently robust to survive isolation from a reaction mixture.

The best mode for carrying out the invention will now be described for the purposes of illustrating the best mode known to the applicant at the time of the filing of this invention. The examples and figures are illustrative only and not meant to limit the invention, as measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

Throughout the description and claims generic groups are often used, for example alkyl, alkoxy, aryl. Unless otherwise specified, the following are preferred group restrictions that may be applied to generic groups found within compounds disclosed herein.

As used herein, “alkyl” will mean linear and branched C₁₋₈-alkyl saturated acyclic hydrocarbon monovalent groups; said alkyl group may further optionally include one or more suitable substituents independently selected from the group consisting of amino, halogen, hydroxy, sulfhydryl, haloalkyl, alkoxy and the like.

As used herein, “alkenyl” will mean straight and branched C₂₋₆ unsaturated acyclic hydrocarbon monovalent groups; said alkenyl group may further optionally include one or more suitable substituents independently selected from the group consisting of amino, halogen, hydroxy, sulfhydryl, haloalkyl, alkoxy and the like.

As used herein, “cycloalkyl” shall mean C₃₋₈ monosaturated hydrocarbon monovalent group, or a C₇₋₁₀ polycyclic saturated hydrocarbon monovalent group.

As used herein, “aryl” shall mean selected from homoaromatic compounds having a molecular weight preferably under 300.

As used herein “heteroaryl” shall mean selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

As used herein “heterocycloalkyl” shall mean selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl.

As used herein “carboxylate derivative” shall mean the group —C(O)OR, wherein R is selected from: hydrogen; C₁-C₆-alkyl; phenyl; C₁-C₆-alkyl-C₆H₅; Li; Na; K; Cs; Mg; and Ca, carbonyl derivative: the group —C(O)R, wherein R is selected from: hydrogen; C₁-C₆-alkyl; phenyl; C₁-C₆-alkyl-C₆H₅ and amine (to give the amide) selected from the group: —NR′₂, wherein each R′ is independently selected from: hydrogen; C₁-C₆-alkyl; C₁-C₆-alkyl-C₆H₅; and phenyl, wherein when both R′ are C₁-C₆-alkyl both R′ together may form an —NC3 to an —NC5 heterocyclic ring with any remaining alkyl chain forming an alkyl substituent to the heterocyclic ring, sulphonate: the group —S(O)₂OR, wherein R is selected from: hydrogen; C₁-C₆-alkyl; phenyl; C₁-C₆-alkyl-C₆H₅; Li; Na; K; Cs; Mg; and Ca.

Unless otherwise specified, the following are more preferred group restrictions that may be applied to groups found within compounds disclosed herein:
(a) alkyl: linear and branched C₁₋₈-alkyl;
(b) alkenyl: C₃₋₈-alkenyl;
(c) cycloalkyl: C₆₋₈-cycloalkyl;
(d) aryL: selected from group consisting of: phenyl; biphenyl; naphthalenyl; anthracenyl; and phenanthrenyl;
(e) heteroaryl: selected from the group consisting of: pyridinyl; pyrimidinyl; quinolinyl; pyrazolyl; triazolyl; isoquinolinyl; imidazolyl; and oxazolidinyl, wherein the heteroaryl may be connected to the compound via any atom in the ring of the selected heteroaryl; and
(f) heterocycloalkyl: selected from the group consisting of: pyrrolidinyl; morpholinyl; piperidinyl; piperidinyl; 1,4-piperazinyl; tetrahydrofuranyl; 1,4,7-triazacyclononanyl; 1,4,8,11-tetraazacyclotetradecanyl; 1,4,7,10,13-pentaazacyclopentadecanyl; 1,4,7,10-tetraazacyclododecanyl; and piperazinyl, wherein the heterocycloalkyl may be connected to the compound via any atom in the ring of the selected heterocycloalkyl, carboxylate derivative: the group —C(O)OR, wherein R is selected from hydrogen; Na; K; Mg; Ca; C₁-C₆-alkyl; and benzyl.

As used herein, and unless otherwise stated, the term “arylalkyl” refers to an aliphatic saturated hydrocarbon monovalent group onto which an aryl group (such as defined above) is attached, and wherein the said aliphatic or aryl groups may be optionally substituted with one or more substituents independently selected from the group consisting of halogen, amino, hydroxyl, sulfhydryl, alkyl, haloalkyl and nitro. Specific examples of the arylalkyl groups are those having 7 to 40 carbon atoms wherein the alkyl group may be straight-chain or branched, such as benzyl, phenylethyl, phenylpropyl, phenylbutyl, phenylpentyl and phenylhexyl groups.

As used herein, and unless otherwise stated, the term “alkylaryl” refers to an aryl group (such as defined above) onto which an aliphatic saturated hydrocarbon monovalent group is attached, and wherein the said aliphatic or aryl groups may be optionally substituted with one or more substituents independently selected from the group consisting of halogen, amino, hydroxyl, sulfhydryl, alkyl, trifluoromethyl and nitro. Specific non-limiting examples of the unsubstituted or alkyl-substituted aryl groups are the aryl groups having 6 to 18 carbon atoms such as phenyl, diphenyl and naphthyl groups, and alkylaryl groups having 7 to 40 carbon atoms wherein the alkyl group may be straight-chain or branched and may be bonded to any position on the aryl group, such as tolyl, xylyl, ethylphenyl, propylphenyl, butylphenyl, pentylphenyl, hexylphenyl, heptylphenyl, octylphenyl, nonylphenyl, decylphenyl, undecylphenyl, dodecylphenyl, diethylphenyl, dibutylphenyl and dioctylphenyl groups. The alkylaryl groups may additionally have substituents including functional groups such as alkoxy, hydroxy, cyano, nitro, halides, carboxylic acids, etc.

As used herein, “Deca-Co-10”, means cobalt neodecanoate, a prevalent cobalt-based prior art drier, as illustrated below.

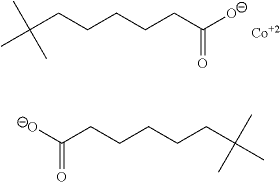

Often, the metal drier, sometimes referred to as a siccative, is present in the curable liquid composition at a concentration of from about 0.0001 and 0.1% w/w, more typically from 0.001 and 0.1% w/w, more typically from 0.002 and 0.05% w/w, even more typically from 0.005 to 0.05% w/w.

The polydentate accelerant ligand, e.g., a tetradentate, pentadentate or hexadentate nitrogen donor ligand, may be built up within any organic structure which will support coordinating nitrogen atoms. For example, one can take a basic tridentate ligand such as 1,4,7-triazacyclononane (TACN), optionally substituted with further nitrogen coordinating groups, e.g., —CH₂—CH₂—NH₂, —CH₂-Py (Py=pyridyl, typically 2-pyridyl), covalently bound to one or more of the nitrogen atoms within the tridentate ligand (e.g., TACN) or aliphatic groups (e.g. one or more of the ethylene diradicals in TACN).

If present, the iron ions may be selected from Fe(II) and/or Fe(III); manganese ions may be selected from Mn(II), Mn(III), and Mn(IV), or vanadium ions selected from V(II), V(III), (III), (IV) and (V), or mixtures thereof. According to some embodiments, the transition metal drier comprises the polydentate accelerant ligand and is a mono- or bidentate ligand of one of the foregoing ions, or a mixture thereof.

The polydentate accelerant ligand (L) may be provided, for example, in complexes of one or more of the formulae: [MnLCl₂]; [FeLCl₂]; [FeLCl]Cl; [FeL(H₂O)](PF₆)₂; [FeL]Cl₂, [FeLCl]PF₆ and [FeL(H₂O)](BF₄)₂ as well as iron carboxylates, e.g., iron neodecanoate. It will be understood that the counteranions shown in the complexes may equally coordinate to other transition metal ions if desired, e.g. of vanadium or manganese.

Below are described classes of polydentate accelerant ligand transition metal driers that are iron or manganese complexes of tetradentate, pentadentate or hexadentate nitrogen donor ligands.

If unspecified, the length of an alkyl chain is C₁-C₈ alkyl and preferably is linear. If unspecified, the length of an alkenyl or alkynyl chain is C₂-C₈ and preferably is linear. If unspecified an aryl group is a phenyl group.

### Bispidon

The bispidon class are typically in the form of an iron transition metal catalyst. The bispidon ligand is preferably of the formula:

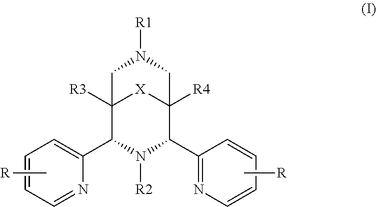

wherein:
each R is independently selected from the group consisting of hydrogen, F, Cl, Br, hydroxyl, C₁₋₄-alkylO—, —NH—CO—H, —NH—CO—C₁₋₄ alkyl, —NH₂, —NH—C₁₋₄-alkyl, and C₁₋₄-alkyl;
R1 and R2 are independently selected from the group consisting of C₁₋₂₄-alkyl, C₆₋₁₀-aryl, and a group containing one or two heteroatoms (e.g. N, O or S) capable of coordinating to a transition metal;
R3 and R4 are independently selected from the group consisting of hydrogen, C₁₋₈-alkyl, C₁₋₈-alkyl-O—C₁₋₆alkyl, C₁₋₈-alkyl-O—C₆₋₁₀-aryl, C₆₋₁₀-aryl, C₁₋₈-hydroxyalkyl and —(CH₂)ₙC(O)OR5 wherein R5 is independently selected from hydrogen and C₁₋₄-alkyl,
n is from 0 to 4
X is selected from the group consisting of C=O, —[C(R6)₂]_{y}— wherein y is from 0 to 3; and
each R6 is independently selected from the group consisting of hydrogen, hydroxyl, C₁₋₄-alkoxy and C₁₋₄-alkyl.

Often R3=R4 and is selected from —C(O)—O—CH₃, —C(O)—O—CH₂CH₃, —C(O)—O—CH₂C₆H₅ and CH₂OH. Often the heteroatom capable of coordinating to a transition metal is provided by pyridin-2-ylmethyl optionally substituted by C₁₋₄alkyl or an aliphatic amine optionally substituted by C₁₋₈alkyl. Often X is C═O or C(OH)₂.

Typical groups for —R1 and —R2 are —CH₃, —C₂H₅, —C₃H₇, -benzyl, —C₄H₉, —C₆H₁₃, —C₈H₁₇, —C₁₂H₂₅, and —C₈H₃₇ and -pyridin-2-yl. An example of a class of bispidon is one in which at least one of R1 or R2 is pyridin-2-ylmethyl or benzyl or optionally alkyl-substituted amino-ethyl, e.g., pyridin-2-ylmethyl or N,N-dimethylamino-ethyl.

Two examples of bispidons are dimethyl 2,4-di-(2-pyridyl)-3-methyl-7-(pyridin-2-ylmethyl)-3,7-diaza-bicyclo[3.3.1]nonan-9-one-1,5-dicarboxylate (N2py3o-C1) and dimethyl 2,4-di-(2-pyridyl)-3-methyl-7-(N,N-dimethyl-amino-ethyl)-3,7-diaza-bicyclo[3.3.1]nonan-9-one-1,5-dicarboxylate and the corresponding iron complexes thereof. FeN2py3o-C1 may be prepared as described in WO 02/48301. Other examples of bispidons are those which, instead of having a methyl group at the 3-position, have longer alkyl chains (e.g. C₄-C₁₈-alkyl or C₆-C₁₈-alkyl chains) such as isobutyl, (n-hexyl) C6, (n-octyl) C8, (n-dodecyl) C12, (n-tetradecyl) C14, (n-octadecyl) C18; these may be prepared in an analogous manner.

### N4py Type

The N4py type ligands are typically in the form of an iron transition metal catalyst. The N4py type ligands are typically of the formula (II):

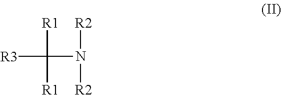

wherein:
each R1 and R2 independently represents —R4—R5;
R3 represents hydrogen, C₁₋₈-alkyl, aryl selected from homoaromatic compounds having a molecular weight under 300, or C₇₋₄₀-arylalkyl, or —R4—R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

Accordingly, to some embodiments R1 or R2 represents pyridin-2-yl; or R2 or R1 represents 2-amino-ethyl, 2-(N-(m)ethyl)amino-ethyl or 2-(N,N-di(m)ethyl)amino-ethyl. If substituted, R5 often represents 3-methyl pyridin-2-yl. R3 preferably represents hydrogen, benzyl or methyl.

Examples of N4Py ligands include N4Py itself (i.e. N, N-bis(pyridin-2-yl-methyl)-bis(pyridin-2-yl)methylamine which is described in WO 95/34628); and MeN4py (i.e. N,N-bis(pyridin-2-yl-methyl-1,1-bis(pyridin-2-yl)-1-aminoethane) and BzN4py (N,N-bis(pyridin-2-yl-methyl-1,1-bis(pyridin-2-yl)-2-phenyl-1-aminoethane) which are described in EP 0909809.

### TACN-Type

The TACN-Nx are preferably in the form of an iron transition metal catalyst. These ligands are based on a 1,4,7-triazacyclononane (TACN) structure but have one or more pendent nitrogen groups that serve to complex with the transition metal to provide a tetradentate, pentadentate or hexadentate ligand. According to some embodiments of the TACN-Nx type of ligand, the TACN scaffold has two pendent nitrogen-containing groups that complex with the transition metal (TACN-N₂). TACN-Nx ligands are typically of the formula (III):

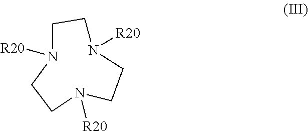

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺ (R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₃-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
wherein at least one of R20 is a —CY₂—R22.

R22 is typically selected from optionally alkyl-substituted pyridin-2-yl, imidazol-4-yl, pyrazol-1-yl, quinolin-2-yl groups. R22 is often either a pyridin-2-yl or a quinolin-2-yl.

### CYCLAM and Cross-Bridged Ligands

The cyclam and cross-bridged ligands are preferably in the form of a manganese transition metal catalyst. The cyclam ligand is typically of the formula (IV):

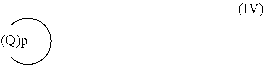

wherein
Q is independently selected from

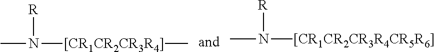

p is 4;
R is independently selected from: hydrogen, C₁₋₆-alkyl, CH₂CH₂OH, pyridin-2-ylmethyl, and CH₂OOOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy.

Examples of non-cross-bridged ligands are 1,4,8,11-tetraazacyclotetradecane (cyclam), 1,4,8,11-tetramethyl-1,4,8,11-tetraazacyclotetradecane (Me4cyclam), 1,4,7,10-tetraazacyclododecane (cyclen), 1,4,7,10-tetramethyl-1,4,7,10-tetraazacyclododecane (Me4cyclen), and 1,4,7,10-tetrakis(pyridine-2ylmethyl)-1,4,7,10-tetraazacyclododecane (Py4cyclen). With Py4cyclen the iron complex is preferred.

A preferred cross-bridged ligand is of the formula (V):

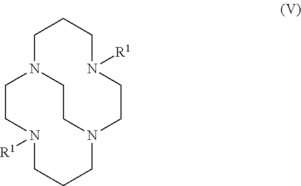

wherein
R¹ is independently selected from H, C₁₋₂₀-alkyl, C₇₋₄₀-alkylaryl, C₂₋₆-alkenyl or C₂₋₆-alkynyl.

All nitrogen atoms in the macropolycyclic rings may be coordinated with a transition metal. In formula (VI), each R¹ may be the same. Where each R¹ is Me, this provides the ligand 5,12-dimethyl-1,5,8,12-tetraaza-bicyclo[6.6.2]hexadecane (L) of which the complex [Mn(L)Cl₂] may be synthesised according to WO98/39098. Where each R1=benzyl, this is the ligand 5,12-dibenzyl-1,5,8,12-tetraaza-bicyclo[6.6.2]hexadecane (L′) of which the complex [Mn(L′)Cl₂] may be synthesised as described in WO 98/39098. Further suitable crossed-bridged ligands are described in WO98/39098.

### TRISPICEN-Type

The trispicens are preferably in the form of an iron transition metal catalyst. The trispicen type ligands are preferably of the formula (VI):

$$R 17 R 17 N - X - NR 17 R 17 , \qquad ( VI )$$

wherein:
X is selected from —CH₂CH₂—, —CH₂CH₂CH₂—, —CH₂C(OH)HCH₂—;
each R17 independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺ (R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.

The heteroatom donor group is preferably pyridinyl, e.g. 2-pyridinyl, optionally substituted by —C₁-C₄-alkyl.

Other preferred heteroatom donor groups are imidazol-2-yl, 1-methyl-imidazol-2-yl, 4-methyl-imidazol-2-yl, imidazol-4-yl, 2-methyl-imidazol-4-yl, 1-methyl-imidazol-4-yl, benzimidazol-2-yl and 1-methyl-benzimidazol-2-yl. Preferably three of R17 are CY₂—R18.

The ligand Tpen (N, N, N′,N′-tetra(pyridin-2-yl-methyl)ethylenediamine) is disclosed in WO 97/48787. Other suitable trispicens are described in WO 02/077145 and EP 1001009A.

Preferably, the ligand is selected from dimethyl 2,4-di-(2-pyridyl)-3-methyl-7-(pyridin-2-ylmethyl)-3,7-diaza-bicyclo[3.3.1]nonan-9-one-1,5-dicarboxylate, dimethyl 2,4-di-(2-pyridyl)-3-methyl-7-(N,N-dimethyl-amino-ethyl)-3,7-diaza-bicyclo[3.3.1]nonan-9-one-1,5-dicarboxylate, 5,12-dimethyl-1,5,8,12-tetraaza-bicyclo[6.6.2]hexadecane, 5,12-dibenzyl-1,5,8,12-tetraaza-bicyclo[6.6.2]hexadecane, N,N-bis(pyridin-2-yl-methyl-1,1-bis(pyridin-2-yl)-1-aminoethane, and N,N-bis(pyridin-2-yl-methyl-1,1-bis(pyridin-2-yl)-2-phenyl-1-aminoethane.

### Other Ligands

Other polydentate accelerant ligands known to those in the art may also be used, and these are discussed below. Typically, these ligands may be used in pre-formed transition metal complexes, which comprise the polydentate accelerant ligand.

Firstly, the polydentate accelerant ligand may be a bidentate nitrogen donor ligand, such as 2,2′-bipyridine or 1,10-phenanthroline, both of which are used known in the art as polydentate accelerant ligands in siccative metal driers. Often 2,2′-bipyridine or 1,10-phenanthroline are provided as ligands in manganese- or iron-containing complexes. Other bidentate polydentate accelerant ligands include bidentate amine-containing ligands. 2-aminomethylpyridine, ethylenediamine, tetramethylethylene-diamine, diaminopropane, and 1,2-diaminocyclohexane.

A variety of bi- to hexadentate oxygen donor-containing ligands, including mixed oxygen- and nitrogen-containing donor ligands, are also known. For example, WO 03/029371 A1 describes tetradentate diimines of the formula:

R₁—C(A₁-O)=N−R₂−N═C(A₂-O)—R₃

wherein:
A₁ and A₂ both are aromatic residues;
R₁ and R₃ are covalently bonded groups, for example hydrogen or an organic group; and
R2 is a divalent organic radical.

The use of 1,3-diketones as polydentate accelerant ligands is described in both EP 1382648 A1 and WO 00/11090 A1, EP 1382648 also describing the use of complexes comprising 1,3-diketones (or 1,3-diimines) and bidentate diamines, including bipyridine and phenanthroline.

A variety of metal driers are described in US 2005/0245639, including vanadium, manganese, iron, cobalt, cerium and lead complexes, including those containing imidazoles and pyrazoles such as those described in WO 00/11090, and aromatic and aliphatic amines.

Of the non-bispidon type siccatives the following are most preferred: 5,12-dimethyl-1,5,8,12-tetraaza-bicyclo[6.6.2]hexadecane, 5,12-dibenzyl-1,5,8,12-tetraaza-bicyclo[6.6.2]hexadecane, 1,4,8,11-tetraazacyclotetradecane, 1,4,8,11-tetramethyl-1,4,8,11-tetraazacyclotetradecane, 1,4,7,10-tetraazacyclododecane, 1,4,7,10-tetramethyl-1,4,7,10-tetraazacyclododecane, and 1,4,7,10-tetrakis(pyridine-2ylmethyl)-1,4,7,10-tetraazacyclododecane, N,N-bis(pyridin-2-yl-methyl)-bis(pyridin-2-yl)methylamine, N,N-bis(pyridin-2-yl-methyl-1,1-bis(pyridin-2-yl)-1-aminoethane, N,N-bis(pyridin-2-yl-methyl-1,1-bis(pyridin-2-yl)-2-phenyl-1-aminoethane and 1,4,7-trimethyl-1,4,7-triazacyclononane.

According to embodiments of the present invention, the oxidatively curable solvent-based coating agent compositions of the invention may contain an antiskinning compound or antioxidant. Examples include, but are not limited to, methylethylketoxime, acetonoxime, butyraldoxime, dialkylhydroxylamine, ascorbic acid, isoascorbate materials as described in WO 2007/024582, acetylacetonate, ammonia, vitamin E (tocopherol), hydroxylamine, triethylamine, dimethylethanolamine, o-cyclohexylphenol, p-cyclohexylphenol and 2-t-butyl-4-methylphenol. In some embodiments, where an antiskinning compound is present this is methylethylketoxime, acetonoxime, butyraldoxime, dialkylhydroxylamine, ammonia, hydroxylamine, triethylamine, dimethylethanolamine, o-cyclohexylphenol, p-cyclohexylphenol, 2-t-butyl-4-methylphenol, or a mixture thereof.

Where present, the concentration of antioxidant or antiskinning compound applied is preferably between about 0.001 and about 2 wt %.

Additionally, one or more auxiliary driers (sometimes referred to as secondary driers) may be present in the curable composition. These may include fatty acid soaps of zirconium, bismuth, barium, vanadium, cerium, calcium, lithium, potassium, aluminum, strontium, and zinc. Preferred fatty acid soaps are octoates, neodecanoates, optionally alkyl-substituted hexanoates and naphthenates. Preferred metal ions in these soaps are zirconium, calcium, strontium and barium. Often such auxiliary driers advantageously diminish the effect of adsorption of the main metal drier on any solid particles often present in the curable composition. Other non-metal based auxiliary driers may also be present if desired. Typical concentrations of these auxiliary dryers are between about 0.01 wt % and about 2.5 wt %.

The coating composition may furthermore contain one or more additives conventionally found in curable coating compositions, such as, but not limited to: UV stabilisers, dispersants, surfactants, inhibitors, fillers, antistatic agents, flame-retardants, lubricants, antifoaming agents, antifouling agents, bactericides, fungicides, algaecides, insecticides, extenders, plasticisers, antifreezing agents, waxes and thickeners.

In certain embodiments, the coating compositions of the present invention comprise at least one colorant. The colorant component of the coating composition may comprise one or more inorganic or organic, transparent or non-transparent pigments. Non-limiting examples of such pigments are titanium dioxide, iron oxides, mixed metal oxides, bismuth vanadate, chromium oxide green, ultramarine blue, carbon black, lampblack, monoazo and diazo pigments, anthraquinones, isoindolinones, isoindolines, quinophthalones, phthalocyanine blues and greens, dioxazines, quinacridones and diketo-pyrrolopyrroles; and extender pigments including ground and crystalline silica, barium sulfate, magnesium silicate, calcium silicate, mica, micaceous iron oxide, calcium carbonate, zinc oxide, aluminum hydroxide, aluminum silicate and aluminum silicate, gypsum, feldspar, talcum, kaolin, and the like. The amount of pigment that is used to form the coating composition is understood to vary, depending on the composition application, and can be zero when a clear composition is desired.

The composition according to the invention can be used as a clear varnish or may contain pigments. Examples of pigments suitable for use are metal oxides, such as titanium dioxide or iron oxide, or other inorganic or organic pigments.

The coating composition may furthermore contain one or more additives such as UV stabilisers, cosolvents, dispersants, surfactants, inhibitors, fillers, anti-static agents, flame-retardant agents, lubricants, anti-foaming agents, extenders, plasticisers, anti-freezing agents, waxes, thickeners, thixotropic agents, etc. Furthermore, the coating composition according to the invention may optionally comprise various anti-oxidants and anti-skinning agents known in the art of the formulation of coating compositions, for example: phenol derivatives, e.g. pyrogallol, 2,6-di-tert.butylhydroxytoluene, hydroquinone, octadecyl-3-(3,5-di-tert.butyl-4-hydroxyphenyl)propionate-Irganox® 1076 (available from Ciba SC), bis(2-mercapto-ethyl)-(3-(3,5-di-tert.butyl-4-hydroxyphenyl)propionate) sulphide-Irganox® 1035 (available from Ciba SC), monomethyl ether of hydroquinone, propenyl phenol, 4-acetoxystyrene, iso-eugenol, lauryl gallate; sulphides, e.g. phenothiazine, dodecylsulphide, di(dodecyl)thiodipropionate; phosphines, e.g. trimethylphosphine, tri-n.octylphosphine, triphenylphosphine; phosphites, e.g. trimethylphosphite, triphenylphosphite, tris(nonylphenyl)phosphite, ethyl-bis(2,4-di-tert.butyl-6-methylphenyl)phosphite-Irgafos®38 (available from Ciba SC), tris(2,4-di-tert.butylphenyl)phosphite-Irgafos®168 (available from Ciba SC), bis(2,4-di-tert.butylphenyl)pentadiphosphite-Ultranox®626 (available from General Electric); phosphonites, e.g. tetrakis(2,4-di-tert. butylphenyl)(1,1-biphenyl)-4,4′-diylbisphosphonite-Irgafos® P-EPQ (available from Ciba SC); dioxo-compounds, e.g. 2,4-pentanedione, dibenzoylmethane, 2,4-hexanedione, 1,3-cyclohexanedione, oxopropionic acid, 2-methyl-3-oxosuccinic acid diethyl ester, oxalacetic acid; oximes, e.g. butanone oxime, butyraldehyde oxime, cyclohexanone oxime; hydroxyacetone, diethylhydroxylamine, 3,5-dimethylpyrazole, ascorbic acid, Hindered Amine Light Stabilisers (HALS), e.g. Tinuvin® 123 (i.e., Bis(1-octyloxy-2,2,6,6-tetramethyl-4-piperidyl)sebacate) and Tinuvin® 292c (i.e., a blend of Bis(1, 2, 2, 6, 6-pentamethyl-4-piperidyl) sebacate & Methyl 1, 2, 2, 6, 6-pentamethyl-4-piperidyl sebacate) available from Ciba SC, 2,3-butenediol, dibenzoyloxybutene, dibenzylthiocarbamic acid zinc salt, Vitamin E, Vitamin E acetate, hypophosphorous acid, 2-butylbenzofuran, 3,4-dihydro-2-ethoxy-2H-pyran, dodecylmercaptane, dicyclopentadiene.

The curable coating composition according to the various aspects of the invention may be used as a decorative coating, e.g., applied to wood substrates, such as door or window frames, or for other substrates such as those made of synthetic materials (such as plastics including elastomeric materials), concrete, leather, textile, glass, ceramic or metal. The curable coating composition according to the various aspects of the invention may be used as an industrial coating, e.g., applied to metal substrates, such as for automotive parts, bridges, equipment or for coil coatings. Thus, the invention also provides a method comprising applying to a substrate a composition according to the second aspect, or obtainable according to the first or third aspects, to a substrate. The thus applied composition may then be allowed to cure. The invention also provides a composition according to the second aspect, or obtainable according to the first or third aspects, when cured.

Thus, the invention also provides a method comprising applying to a substrate a composition according to the second aspect, or obtainable according to the first or third aspects, to a substrate. The thus applied composition may then be allowed to cure. The invention also provides a composition according to the second aspect, or obtainable according to the first or third aspects, when cured.

Any known method can be used to apply the coating compositions of the invention to a substrate. Non-limiting examples of such application methods are spreading (e.g., with paint pad or doctor blade, or by brushing or rolling), spraying (e.g., air-fed spray, airless spray, hot spray, and electrostatic spray), flow coating (e.g., dipping, curtain coating, roller coating, and reverse roller coating), and electrodeposition. (See generally, R. Lambourne, Editor, Paint and Surface Coating: Theory and Practice, Eilis Horwood, 1987, page 39 et seq.).

The coating compositions of the present invention can be applied and fully cured at ambient temperature conditions in the range of from about −10° C. to 50° C. Curing of said polymer composition according to the invention typically can proceed very rapidly, and in general can take place at a temperature within the range of from −10° C. to +50° C., in particular from 0° C. to 40° C., more in particular from 3° C. to 25° C. However, compositions of the present invention may be cured by additional heating.

The coating compositions of the present invention may be used as a single coating, a top coating, a base coating in a two-layered system, or one or more layers of a multi-layered system including a clear top coating composition, colorant layer and base coating composition, or as a primer layer. A typical opaque system may comprise: 1 or 2 layers of primer and 1 or 2 layers of top coat (a total of 3 layers). Alternative opaque systems may comprise: 1 primer layer, 1 layer of mid coat and 1 layer top coat. Examples of transparent systems may comprise 1 layer of impregnant and 3 layers of top coats or 3 layers of top coat for maintenance work.

The invention will be more readily understood by reference to the following examples, which are included merely for purpose of illustration of certain aspects and embodiments of the present invention and are not intended to limit the invention.

As used in this application, BOC is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3, kN7]-, chloride(1:1) illustrated below.

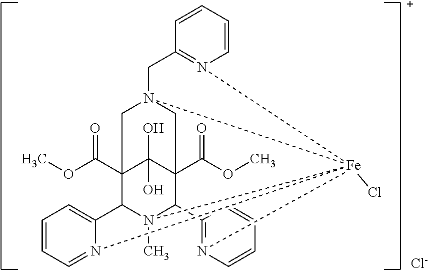

As used herein, TMTACN is 1,4,7-trimethyl-1,4,7-triazonane illustrated below.

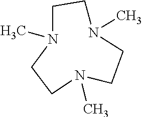

As used herein, Borchi® Dragon is a product from Borchers containing manganese neodecanoate and TMTACN.

As used herein, Ultraset® 248D means a manganese borate neodecanoate complex dissolved in white spirit.

As used herein, Borchers® Deca Manganese 8 HS, Deca Mn 8 HS, means a 7.8-8.2% Mn neodecanoic acids in a fatty acid ester solvent.

As used herein, Borchers® Deca Copper 8, Deca Copper 8, means a 7.8-8.2% Cu Copper(2+) Neodecanoate 45-55% CAS 68084-48-0 in a solvent 35-45% Hydrocarbons, C10-C13, n-alkanes,-isoalkanes, cyclics, <2% aromatics CAS 918-481-9.

The sulfur analogs of alcohols may be called thiols. More traditionally, thiols are referred to as mercaptans. The functional group of a thiol is an —SH end group bonded to a carbon atom. Polythiols may range from di-functional up to hexafunctional. A thiol or thiol derivative is any organosulfur compound of the form R—SH, where R represents an alkyl or other organic substituent. The —SH functional group itself is referred to as either a thiol group or a sulfhydryl group, or a sulfanyl group.

TABLE A
Thiols Studied

| | | Sample | SH | SH | M.W. |
|---|---|---|---|---|---|
| CAS RN | Chemical Name | Name | Functionality | Content % | (g/mol) |
| 123-81-9 | Ethylene bis(thioglycolate) | ME-2 | 2 | 26.8 | 238.3 |

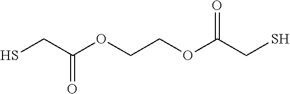 [SMILES: O=C(CS)OCCOC(=O)CS]

Sample “A”

| | | | | | |
|---|---|---|---|---|---|
| 13007-83-9 | Trimethylolpropane tris(3- | ME-3 | 3 | 24 | 398.6 |
| | mercaptopropionate) | | | | |

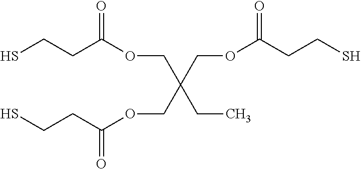 [SMILES: CCC(COC(=O)CCS)(COC(=O)CCS)COC(=O)CCS]

Sample “B”

| | | | | | |
|---|---|---|---|---|---|
| 7575-23-7 | Pentaerythritol tetrakis(3- | ME-4 | 4 | 26 | 488.6 |
| | mercaptopropionate) | | | | |

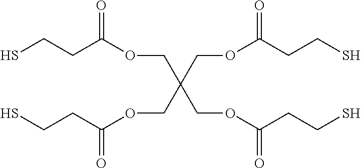 [SMILES: O=C(CCS)OCC(COC(=O)CCS)(COC(=O)CCS)COC(=O)CCS]

Sample “C”

| | | | | | |
|---|---|---|---|---|---|
| 25359-71-1 | Dipentaerythritol hexakis(3- | ME-6 | 6 | 24.1 | 783.1 |
| | mercaptopropionate) | | | | |

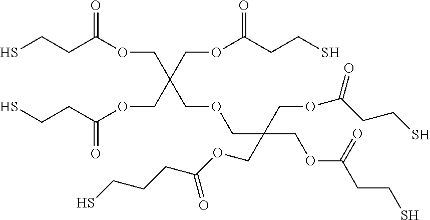 [SMILES: O=C(CCS)OCC(COCC(COC(=O)CCS)(COC(=O)CCS)COC(=O)CCCS)(COC(=O)CCS)COC(=O)CCS]

Sample “D”

| | | | | | |
|---|---|---|---|---|---|
| 674786-83-5 | Thiocure 332 (ETTMP 700) a | TH-332 | 3 | 13.5 | 700 |
| | mercaptoalkionate | | | | |
| | Ethoxylated trimethylolpropane | | | | |
| | tri (3-mercaptopropionate) | | | | |

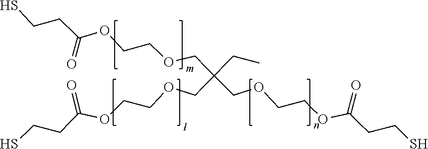

The molecular weight of segments for l + m + n being adjusted so that the MW totals to ~700 and
wherein l + m + n independently total to ~ a range between 10-40
Sample E

| | | | | | |
|---|---|---|---|---|---|
| 345352-19-4 | Thiocure 333 (ETTMP 1300) a | TH-333 | 3 | 7.1 | 1300 |
| | mercaptoalkionate | | | | |
| | Ethoxylated trimethylolpropane | | | | |
| | tri (3-mercaptopropionate) | | | | |

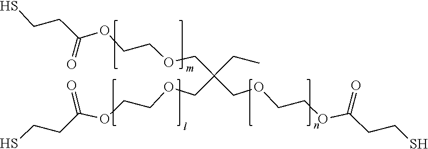

The molecular weight of segments for l + m + n being adjusted so that the MW totals to ~1300 and
wherein l + m + n independently total to ~ a range between 10-40
Sample F

| | | | | | |
|---|---|---|---|---|---|
| 1622079-69-9 | Thiocure 341 (PCL4MP 1350) | TH-341 | 4 | 9.1 | 1350 |
| | Polycaprolactone Tetra (3- | | | | |
| | mercaptoproprionate) | | | | |

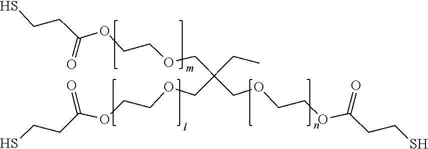

The molecular weight of segments for l + m + n being adjusted so that the MW totals to ~1350 and
wherein l + m + n independently total to ~ a range between 10-40
Sample G

The above Thiocure® polythiols are synthesized by esterification of mercaptocarboxylic acids and polyfunctional alcohols and commercially available from Bruno Bock Chemische Fabrik GmbH & Co. KG.

In a more generic form, the thiol and/or polythiol may be represented as follows:

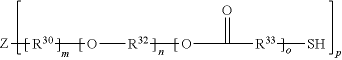

wherein
Z is a covalently bonding bridging moiety;
R³⁰ is independently selected from the group consisting of a C₁₋₃₀branched or straight chain alkyl; C₁₋₃₀branched or straight chain alkenyl, C₅₋₄₅-cycloalkyl, C₅₋₄₅-cycloalkenyl, C₆-45-aryl, C₆₋₄₅-arylalkyl, C₆₋₄₅-alkylaryl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and
R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and further wherein R³⁰ or Z are heteroatoms based on O, N, S, or P; e.g., an epoxy group; or a siloxane or polysiloxane group such as dimethylsiloxane, branched or linear equivalents, that can also contain additional functionality such as an acrylate, unsaturated carbon-carbon bonds, alcohol or acid groups, the crosslinker can for example be silicone-thiol resin; R³⁰ or Z groups can be an alcohol functionality—the thiol crosslinker may consist of acrylic or polyacrylic groups that may have comonomers or monomers with functionality such as free allyl groups, free thiol groups, unsaturated carbon-carbon-bonds such as the use of ethylene glycol dimethacrylate, or alcohol groups incorporated by use of hydroxyethylmethacrylate, or acids for example from acrylic acid, or epoxy groups; polymeric crosslinkers can also be made from polyurethanes, polyesters, and other polymers known;
R³² and R³³ are selected from the group identified for R³⁰;
m, n, and o are independently 0 or 1; and
p is an integral value from 1 to 10; and
wherein the siloxane or polysiloxane is linear or branched polymer or derivatized polymer with acetoxy, oxime, amine, or alkoxy substituents having a weight average (M_{w}) molecular weight of between 200-50,000, more preferably 500-10,000, and most preferably 1,000-5,000, and may further comprise a copolymers thereof including copolymers of polypropylene oxide and polyethylene oxide:

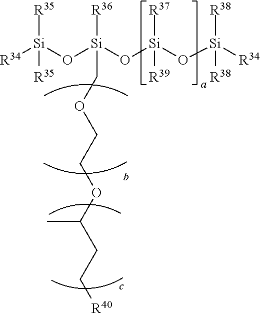

and wherein
R³⁴ to R⁴⁰ are independently selected from the group for R³⁰ above; and
a, b, and c are independently selected from 0 to 3,000 inclusive.

Examples of suitable thiol compounds include, but are not limited to, the esters of thioglycolic acid, 2-mercapto-propionic acid or 3-mercaptopropionic acid with polyols, such as glycols, pentaerythritol, di-pentaerythritol and trimethylolpropane, and optionally a fatty acid, such as oleic acid, stearic acid, isononanoic acid or sunflower fatty acid. Specific examples of suitable thiol compounds are ethylene glycol bis (thioglycolate), ethylene glycol bis (2-mercaptopropionate), ethylene glycol bis (3-mercaptopropionate), pentaerythritol tetrakis (thioglycolate), pentaerythritol tetrakis (2-mercaptopropionate), pentaerythritol tetrakis (3-mercaptopropionate), trimethylolpropane tris(2-mercaptopropionate), trimethylolpropane tris(3-mercaptopropionate), and the condensation product of di-trimethylolpropane, 2,2-dimethylolpropionic acid, stearic acid, and 3-mercaptopropionic acid. An example of a commercial silicone-thiol can be, for example, Silmer SH Q20 (i.e., silicon thiol resin with very high cross-link density—Silmer SH Q20 contains no dimethyl silicone groups to maximize the hardness of the materials cured from it—Appearance Clear to slightly hazy liquid Viscosity, cPs 15,000 Active Content, % 100 SH content, % 14.2 Odor Distinctive but mild) or Silmer SH 208-30Q (i.e., silicon thiol resin with very high cross-link density—Silmer SH 208-30Q contains no dimethyl silicone groups to maximize the hardness of the materials cured from it—Appearance Clear to slightly hazy liquid Viscosity, cPs 3,000 Active Content, % 100 SH content, % 14.6 Odor Distinctive but mild).

Preferably, the coating composition comprises 1-30 wt. % of thiol compounds, related to the total weight of solid resin, more preferably 3-20 wt. % of thiol compounds. The thiols may for example have a weight average (M_{w}) molecular weight of ˜200-˜50,000 inclusive, more preferably ˜1,000-˜10,000 inclusive, and most preferably ˜500-˜5,000 inclusive and preferred ˜750-˜2000.

Any compound having at least one (preferably two or more) thiol (—SH) functional groups may be advantageously used as a (poly)thiol compound in the compositions of the present invention. For example, the (poly)thiol compound may contain three or more thiol groups, four or more thiol groups or five or more thiol groups.

A (poly)thiol compound could be a branched or a hyperbranched polymer, containing a range of thiol groups from 2 to 100. It could also be a particle, functionalized with thiol or thiol and alkene groups.

Further, the (poly)thiol in various embodiments of the invention has a weight average (M_{w}) molecular weight of at least 350 Daltons, at least 375 Daltons, at least 400 Daltons, at least 425 Daltons or at least 450 Daltons and/or has a molecular weight not greater than 2000 Daltons, not greater than 1750 Daltons, not greater than 1500 Daltons, not greater than 1250 Daltons or not greater than 1000 Daltons. For example, the (poly)thiol may, in various embodiments, have a weight average (M_{w}) molecular weight of from 350 Daltons to 2000 Daltons or more preferably 400 Daltons to 1000 Daltons.

Suitable (poly)thiols for use in the present invention may also be characterized with respect to their thiol equivalent weight (calculated by dividing the molecular weight of the (poly)thiol by the number of thiol functional groups per molecule). In various embodiments of the invention, the (poly)thiol compound has a thiol equivalent weight of at least 80 Daltons, at least 90 Daltons, at least 95 Daltons or at least 100 Daltons and/or a thiol equivalent weight of not more than 450 Daltons, not more than 400 Daltons, not more than 350 Daltons, not more than 300 Daltons, not more than 250 Daltons or not more than 200 Daltons. For example, the thiol equivalent weight of the (poly)thiol compound may be from 80 Daltons to 450 Daltons, from 90 Daltons to 400 Daltons or from 100 Daltons to 200 Daltons.

Additionally, it will generally be desirable to select a (poly)thiol compound or combination of (poly)thiol compounds having low odor. For example, the (poly)thiol(s) may be sufficiently low in odor that the coating or sealant composition containing the (poly)thiol(s) does not have any sulfur odor discernable to a human olfactory system when the composition is spread as a layer on a substrate surface at 25° C. In other embodiments, the (poly)thiol compound(s) used has a relatively high flash point, e.g., a flash point of at least 100° C., as measured by ASTM D92-12b.

According to various embodiments of the invention, the polythiol compound may be a monomer, an oligomer or a polymer (i.e., the backbone or skeleton of the polythiol compound may be monomeric, oligomeric or polymeric in character). Each thiol group may be attached to the skeleton or backbone of the polythiol compound either directly or via a linking moiety.

In certain embodiments of the present invention, the (poly)thiol compound is a thiol-functionalized ester of a polyalcohol (a compound containing two or more alcohol functional groups).

The following may be mentioned by way of example as polyalcohols suitable for esterifying with a thiol-functionalized carboxylic acid to provide a (poly)thiol compound: alkanediols, such as butanediol, pentanediol, hexanediol, alkylene glycols, such as ethylene glycol, propylene glycol and polypropylene glycol, glycerin, 2-(hydroxyl methyl)propane-1,3-diol, 1,1,1,-tris(hydroxymethyl)ethane, 1,1,1-trimethylolpropane, di(trimethylolpropane), tricyclodecane dimethylol, 2,2,4-trimethyl-1,3-pentanediol, bisphenol A, cyclohexane dimethanol, alkoxylated and/or ethoxylated and/or propoxylated derivatives of neopentyl glycol, tetraethylene glycol cyclohexanedimethanol, hexanediol, 2-(hydroxymethyl)propane-1,3-diol, 1,1,1-tris(hydroxymethyl)ethane, 1,1,1-trimethylolpropane and castor oil, pentaerythritol, sugars, sugar alcohols or mixtures thereof.

Suitable (poly)thiol compounds include esters of α-thioacetic acid (2-mercaptoacetic acid), β-thiopropionic acid (3-mercaptopropionic acid) and 3-thiobutyric acid (3-mercaptobutyric acid), wherein such acids are esterified with diols, triols, tetraols, pentaols or other polyols, such as 2-hydroxy-3-mercaptopropyl derivatives of diols, triols, tetraols, pentaols or other polyols. Mixtures of alcohols may also be used as a basis for the thiol-functionalized compound.

Examples of suitable polythiol compounds which may be mentioned are: glycol-bis(2-mercaptoacetate), glycol-bis(3-mercaptopropionate), 1,2-propylene glycol-bis(2-mercaptoacetate), 1,2-propylene glycol-bis(3-mercaptopropionate), 1,3-propylene glycol-bis(2-mercaptoacetate), 1,3-propylene glycol-bis(3-mercaptopropionate), tris(hydroxymethyl)methane-tris(2-mercaptoacetate), tris(hydroxymethyl)methane-tris(3-mercaptopropionate), 1,1,1-tris(hydroxymethyl)ethane-tris(2-mercaptoacetate), 1,1,1-tris(hydroxymethyl)ethane-tris(3-mercaptopropionate), 1,1,1-trimethylolpropane-tris(2-mercaptoacetate), ethoxylated 1,1,1-trimethylolpropane-tris(2-mercaptoacetate), propoxylated 1,1,1-trimethylolpropane-tris(2-mercaptoacetate), 1,1,1-trimethylol propane-tris(3-mercaptopropionate), ethoxylated 1,1,1-trimethylolpropane-tris(3-mercaptopropionate), propoxylated trimethylolpropane-tris(3-mercaptopropionate), 1,1,1-trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptobutyrate), Capcure® 3-800 (Gabriel Performance Products, LLC) (e.g., CAPCURE®3-800 curing agent is a unique polymercaptan epoxy hardener which, when used with a catalyst, provides very rapid cures of epoxy systems, even in thin films and at low temperatures. The catalyst is an integral part of a CAPCURE® 3-800 system. The action of a properly selected catalyst can provide gel times as short as 4 minutes), GPM-800 (Gabriel Performance Products LLC (GABEPRO™ GPM-800 curing agent is a unique polymercaptan epoxy hardener which, when used with a catalyst, provides very rapid cures of epoxy systems, even in thin films and at low temperatures. The catalyst is an integral part of a GPM-800 system. The action of a properly selected catalyst can provide gel times as short as 4 minutes), Capcure® LOF (Gabriel Performance Products, LLC) (Low odor and low skinning uncatalyzed polymercaptan, Color, Gardner <2.0, Mercaptan value >3.0 meg/g, Viscosity @25° C., Brookfield 100-200 poise. Specific gravity @25° C. 1.15), GPM-800LO (Gabriel Performance Products LLC) (GABEPRO™ GPM-800 curing agent is a mercaptan (—SH) terminated liquid curing agent which imparts rapid-cure characteristics to epoxy resins in combination with selected amines. These systems are unique in that they also provide rapid cure rates at low temperatures and in thin films, Color, Gardner 1.0 max Moisture, Dean Stark, Wt % 0.3 max Mercaptan Value, meq/g 3-4 Viscosity (Brookfield) at 25° C., cP 10,000-15,000 Density, g/cm3 1.15 pH 3.0-5.0 Chloride, Wt % 0.15 max), KarenzMT PE-1 (Showa Denko) (i.e., Pentaerythritol tetrakis (3-mercaptobutylate), 2-ethylhexylthioglycolate, iso-octylthioglycolate, di(n-butyl)thiodiglycolate, glycol-di-3-mercaptopropionate, 1,6-hexanedithiol, ethylene glycol-bis(2-mercaptoacetate) and tetra(ethylene glycol)dithiol.

Such (poly)thiol compounds may be prepared by any method known in the art or obtained from commercial sources, such as the polythiols sold under the trade name “Thiocure®” in Table A by Bruno Bock.

The (poly)thiol compound may be used alone or as a combination of two or more different polythiol compounds.

Other Crosslinker Types Vs. Thiol Type

| | | Sample | Type of chemical |
|---|---|---|---|
| CAS RN | Chemical Name | Name | function |
| 7575-23-7 | Pentaerythritol tetrakis(3- | ME-4 | Polythiol (C) |
| | mercaptopropionate) | | |

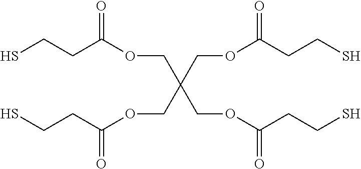 [SMILES: O=C(CCS)OCC(COC(=O)CCS)(COC(=O)CCS)COC(=O)CCS]

| | | | |
|---|---|---|---|
| 16646-44-9 | Glyoxal bis(diallylacetal) | GDA | Polyallyl (H) |

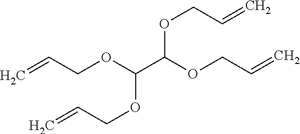 [SMILES: C=CCOC(OCC=C)C(OCC=C)OCC=C]

| | | | |
|---|---|---|---|
| 15022-08-9 | Diallyl carbonate | DA | Polyallyl (I) |

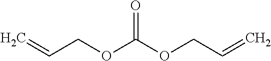

| | | | |
|---|---|---|---|
| 1321-74-0 | Divinyl benzene (80%) | DVB | Divinyl (J) |

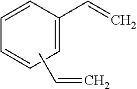

| | | | |
|---|---|---|---|
| 13048-33-4 | 1,6-hexanediol-diacrylate | HED | Diacrylate (K) |

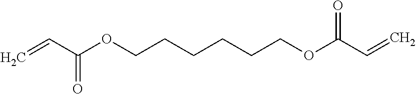 [SMILES: C=CC(=O)OCCCCCCOC(=O)C=C]

| | | | |
|---|---|---|---|
| 800-20-5 | Tung Oil | TO | Fatty Acid (L) |

~82% a-eleostearic acid
~8.5% linoleic acid
~5.5% palmitic acid
~4.0% oleic acid

### Experimental Methods Used.

### Sample Preparation:

All the ingredients of a specific formulation were poured into a 50 ml polypropylene mixing cups. The polypropylene mixing cups were then placed in a DAC 150.1 FVZ speed mixer and mixed at 2000 rpm speed for 2 minutes. After the mixing, the samples were stored in the laboratory, at room temperature for 24 hours prior any testing.

Unless otherwise stated, the mass of Borchi® OXY-Coat (BOO) (see Glossary) and Borchi® Dragon (se Glossary) was 1% based on resin solids and was calculated as explained in equation 1below

$${m}_{BOC or Borchi Dragon} = \frac{α {m}_{resin} \times 1}{100}$$

Where α is the fraction solid content of the resin as a percent (for example, using 0.5 for 50%), mᵣₑₛᵢₙ the mass of the resin used, and 1 is a figure that corresponds to the loading level of BOC, in this case as 1% wt of BOC or Borchi Dragon on resin solids.

Unless otherwise stated, the mass of Borchers® Deca Cobalt 10, (cobalt salt of neodecanoic acid) was calculated as metal on resin solids, and was calculated according to Equation 2:

$${m}_{Catalyst} = \frac{α {m}_{resin} \times a}{β}$$

Where α is the solid content of the resin as a percent, mᵣₑₛᵢₙ the mass of the resin, α the percentage of catalyst used and β is the metal content in % of the selected catalyst.

For Borchers® Deca Cobalt 10 (cobalt salt of neodecanoic acid), α=0.07% and β=10%.

Unless otherwise stated, the mass of polythiol used 5% was based on resin solid and calculated according to Equation 3:

$${m}_{Polythiol} = \frac{α {m}_{resin} \times 5}{100}$$

Where a is the solid content of the resin as a percent (for example, using 0.5 for 50%), mᵣₑₛᵢₙ the mass of the resin used, and 5 is a figure that corresponds to the loading level of polythiol, in this case as 5% wt of polythiol on resin solids.

Unless otherwise stated, all the values of formulation Tables refers to mass in gram (g), the values of hardness Tables are in seconds (s) and the values of dry time Tables are in hours (h).

### Dry Time Recording:

To monitor the drying time of the coatings, B. K drying recorders were used. The solution was coated on a glass stripes using a manual film applicator of 100 μm. The drying recorder was run for 24 h. After 24 h, drying time was assessed with the graduation scale (according to traverse 24 h speed configuration). 6 samples were tested simultaneous. Each sample was repeated twice. The measurement was performed in a climate-controlled room at 23° C. and 50% humidity. The Set to touch (ST), Tack free (TF) and Dry hard (DH) times were then evaluated.

### König Pendulum Hardness Measurement:

The pendulum hardness was measured using a TQC Sheen Pendulum Hardness Tester. It defined hardness by the König method as described in ISO 1522. König method worked on the principle that the damping time of a pendulum oscillating on a sample indicated the hardness. The TQC tester was calibrated using a glass calibration panel (VF2063, 250+/−10 seconds—König method). SP0505 König Pendulum was used. These measurements were performed in the climate-controlled room at 23° C. and 50% humidity. The coated panels (100 μm wet film thickness) were stored in this climate room prior the hardness measurement. The hardness was measured on three different points of the coated plate, after 1 day, 7 days and 14 days dry time.

### Scratch Test Using a Mechanized Scratch Tester (705):

The Mechanised Scratch Tester (705) was dedicated to coatings hardness evaluation based on the scratching resistance method. A test panel was clamped on the test bed and slowly moved whilst a stylus or alternative tool scratched its surface. Depending on test procedures, specified or variable loads can be applied to obtain different degrees of failure, from trace to destruction. A voltmeter mounted in the front panel indicated contact of the tool tip with the metallic sample substrate. The testing method was adapted from ASTM D5178-16 as follows: (i) the coated metal plates were placed 1 h at 10000 to ensure complete curing (ii) the plates were then placed at least 48 h at 23° 50% humidity (climate-controlled room) (iii) the test was performed in the climate room too (iv) the 1 mm tungsten carbide hemispherical tip was cleaned before each scratch (v) the film thickness was measured using a BYKO-test MP0R (coating thickness measuring instrument). The travel speed 30 mm/s to 40 mm/s and travel distance 75 mm. The experiment was started from high weight and the weight was decreased weight until no scratch was visible (critical weight). Then on a second panel, 5 scratches were performed at critical weight, 100 g above critical weight and 100 below critical weight. The number of times the coated was scratched for each weight was reported at 1 days, 3 days, and 7 days after scratching.

### Glossary

| Chemical Name | Shorthand Notation |
|---|---|
| Ethylene Bis(thioglycolate) | ME-2 |
| Trimethylolpropane Tris(3-mercaptopropionate) | ME-3 |
| Pentaerythritol tetrakis(3-mercaptopropionate) | ME-4 |
| Dipentaerythritol Hexakis(3-mercaptopropionate) | ME-6 |
| Thiocure 332 (ETTMP 700) ethoxylated | Th-332 |
| trimethlolpropane tri(3-mercaptopropionate) | |
| Thiocure 333 (ETTMP 1300) ethoxylated | Th-333 |
| trimethylolpropane tri(e-mercaptopropionate) | |
| Thiocure 341 (PCL4MP 1350) (polycaprolactone tetra | Th-341 |
| (3-mercaptopropionate)) | |
| Glyoxal bis(diallyl acetal) | GDA |
| Diallyl carbonate | DA |
| Divinyl benzene, 80% | DVB |
| 1,6-Hexandiol-diacrylat | HED |
| Tung oil | TO |
| Iron(1+), chloro[dimethyl-9,9-dihydroxy-3-methyl-2,4-di- | BOC or BOC |
| (2-pyridinyl-kN)-7-[(2-pyridinyl-kN)methyl]-3,7- | 1101 or |
| diazabicyclo[3.3.1]nonane-1,5-dicarboxylate-kN3, | Borchi ® Oxy |
| kN7]-, chloride(1-) CAS 478945-46-9 | Coat |
| Borchers ® Deca Cobalt 10 (cobalt neodecanoate) | Deca Co 10 |
| manganese neodecanoate and TMTACN | Borchi Dragon |
| 1,4,7-Trimethyl-1,4,7-triazacyclononane | TMTACN |
| Thiocyanuric Acid | TCA |
| (3-Mercaptopropyl)trimethoxysilane | MESi |
| 1,3-Benzenedithiol | BDT |
| 3,6-Dioxa-1,8-octanedithiol | DODT |
| Tris[2-(3-mercaptopropionyloxy)ethyl] Isocyanurate | TMIC |
| 2,3-Dimercapto-1-propanol | DMP |
| Allyl Mercaptan | AM |
| 1,5-Dimercaptonaphthalene | DMNP |
| Methoxypropyl Acetate | MPA |
| Borchi ® Gen 1252 (high molecular weight, VOC- and | BGen 1252 |
| APEO-free wetting and dispersing agent acrylic ester | |
| copolymer) | |
| AEROSIL ® R 972 (fumed silica after treated with DDS | Aerosil R972 |
| (dimethyldichlorosilane)) | |
| KRONOS ® 2360 (white TiO₂ pigment) | Kronos 2360 |
| Exxsol ™ D60 (low odor, low aromatic hydrocarbon | Exxol D 60 |
| solvent. The major components include normal | |
| paraffins, isoparaffins, and cycloparaffins) | |
| Ascinin ® Anti Skin 0445 (Anti-skinning agent for solvent- | 445 |
| and water-based oxidatively cured coating systems, | |
| MEKO-free, phenol-free - Viscosity 30 - 130 mPa.s ISO | |
| 3219 (A) (20° C.) - Density 0.99 - 1.03 g/cm3 - DIN | |
| 51757 (20° C.) - Solvent Glycol - Amino compound | |
| dissolved in 1,2-propanediol | |
| Borchi ® Gen 0755 (polyurethane polymer) | BGen 0755 |
| AEROSIL ® R 972 (hydrophobic fumed silica) | Aerosil R 972 |
| BAYFERROX ® 130 M (micronized iron oxide red | Bayferrox 130M |
| pigment) | |
| Dimethylglutarate | DBE-5 |
| Silmer SH ® Q20 (a silicon thiol resin with very high | Silmer SH Q20 |
| cross-link density - Silmer SH Q20 contains no dimethyl | |
| silicone groups to maximize the hardness of the | |
| materials cured from it - typical properties - appearance | |
| clear to slightly hazy liquid; viscosity, cPs 15,000; active | |
| content, %100; SH content, %14.2; odor distinctive but | |
| mild) | |
| Silmer SH ® 208-30Q (a silicon thiol resin with very high | Silmer SH |
| cross-link density - Silmer SH 208-30Q contains no | 208-30Q |
| dimethyl silicone groups to maximize the hardness of | |
| the materials cured from it - typical properties - | |
| appearance clear to slightly hazy liquid; viscosity, cPs | |
| 3,000; active content, %100; SH content, %14.6; odor | |
| distinctive but mild) | |
| 51% Soya oil; 23% phthalic anhydride; Color DIN ISO | WorléeKyd ® |
| 4830, Gardner, max. 10 (40% in dearomatized | S351 |
| hydrocarbon 180-220); Acid value DIN EN ISO 3682 | |
| [mgKOH/g] max. 10; flow time Flow time 20° C. DIN | |
| 3211-4 [s] 130-190 (80% in ws 145-195) | |
| a high solids long oil alkyd resin - solid content at 125° C., | Synolac 4060 |
| % (ISO 3251) 88-90; Viscosity at 25° C., mPa · s | WAD 90 |
| (Brookfield LVDV-II+, SC4-34, 20 rpm) (ISO 3219) 1500- | |
| 2500; Colour, Gardner scale (ISO 4630) 8 max; acid | |
| value, mg KOH/g (ISO 2114) 10 max; flash point, ° C. | |
| (ISO 3679) 62; Density/Specific Gravity at 25° C., g/ml | |
| (ISO 2811) 0.99; Type of fatty acid Linoleic rich; Fatty | |
| Acid content, %72 | |

In the following tables providing formulation content, where not specified, all ingredients are given in mass (g).

Influence of Thiol Functionality, Crosslinker Type and SH Content The first investigation was for the influence of SH number functions. The formulation and dosage used are given in Table 1. The characteristics of the polythiols are given in Table 2. In Table 3, it was demonstrated that the polythiols ME-2, 3, 4 and 6 in combination with BOC, increased the hardness compared to BOC used alone. However, polythiol Th-332, Th-333 and Th-341 did not help to increase the hardness. It was discovered that the SH %-content (based on weight average (M_{w}) molecular weight) was more important than the number of SH groups per molecule of crosslinker. Indeed, ME-3 with Th-332 and Th-333 all had 3 SH functionalities per molecule of crosslinker, but they presented very different results in term of performance. When comparing their SH % content, It could be seen that Th-332 and Th-333 had about half or lower SH % content than ME-3. Same observation with ME-4 and Th-341. It was concluded that if a polymer version is used or made, then the SH % content should be kept at least at 23%. Finally, it was unexpectedly noted that polythiols could not be used with Cobalt catalyst as they cancelled the efficiency of the cobalt. The coatings with a combination of cobalt and polythiol were purple-red and the dry time increased over the standard dry time of cobalt (Table 4). In Table 4 it was shown that the addition of thiol to BOC improves the standard BOC dry time when using thiols ME-2, -3, -4, -6, as well as Th-332, -333 and -341. The SH content % was calculated using Equation 4, where 33 is the relative molecular mass of SH, x is the number of thiol groups per molecule and M is the molar mass of the crosslinker molecule.

$$SH \% = \frac{33 x}{{M}_{molecule}} \times 100 \qquad Equation 4$$

TABLE 1
Formulation of solvent borne Worléekyd ® S351 medium oil alkyd
used in combination with polythiols cross linker and primary driers.

| Sample name | 1 | 2 | 3 | 4 | 5 | 6 | 7 | 8 | 9 | 10 | 11 | 12 | 13 |
|---|---|---|---|---|---|---|---|---|---|---|---|---|---|
| WorléeKyd ® | 10 | 10 | 10 | 10 | 10 | 10 | 10 | 10 | 10 | 10 | 10 | 10 | 10 |
| S351 (~60% | | | | | | | | | | | | | |
| solid) | | | | | | | | | | | | | |
| ME-2 | | 0.3 | | | | | 0.3 | | | | | | |
| ME-3 | | | 0.3 | | | | | 0.3 | | | | | |
| ME-4 | | | | 0.3 | | | | | 0.3 | | | | |
| ME-6 | | | | | 0.3 | | | | | 0.3 | | | |
| Th-332 | | | | | | | | | | | 0.3 | | |
| Th-333 | | | | | | | | | | | | 0.3 | |
| Th-341 | | | | | | | | | | | | | 0.3 |
| BOC | 0.06 | 0.06 | 0.06 | 0.06 | 0.06 | | | | | | 0.06 | 0.06 | 0.06 |
| Deca-Co-10 | | | | | | 0.042 | 0.042 | 0.042 | 0.042 | 0.042 | | | |

TABLE 2
Description of polythiol used as cross linker in solvent borne alkyd
medium oil resin WorléeKyd ® S351.

| | | | Molecular weight |
|---|---|---|---|
| Sample name | SH functionality | SH-content % | (g/mol) |
| ME-2 | 2 | 26.8 | 238.3 |
| ME-3 | 3 | 24.0 | 398.6 |
| ME-4 | 4 | 26.0 | 488.6 |
| ME-6 | 6 | 24.1 | 783.1 |
| Th-332 | 3 | 13.5 | 700.0 |
| Th-333 | 3 | 7.1 | 1300.0 |
| Th-341 | 4 | 9.1 | 1350.0 |

TABLE 3
König hardness of WorléeKyd ® S351 resin and polythiols 5% on resin solid,
using drier BOC 1% on resin solids or Deca-Co-10 0.07% metal on resin solids.

| König Hardness (s) | 1 | 2 | 3 | 4 | 5 | 6 | 7 | 8 | 9 | 10 | 11 | 12 | 13 |
|---|---|---|---|---|---|---|---|---|---|---|---|---|---|
| After 1 day | 14 | 19.6 | 21 | 26.6 | 26.6 | 19.6 | 2.7 | 5.6 | 5.5 | 6.9 | 15.2 | 14 | 16.8 |
| After 7 days | 28 | 44.9 | 44.8 | 49.1 | 47.6 | 40.6 | 2.7 | 25.2 | 14 | 11.1 | 26.6 | 21 | 26.6 |
| After 14 days | 36.5 | 63.1 | 56.1 | 70.1 | 58.9 | 56.2 | 2.7 | 43.4 | 15.4 | 14 | 25.2 | 18.2 | 25.2 |

TABLE 4
Dry time of WorléeKyd ® S351 resin and polythiols 5% on resin solids,
using drier BOC 1% on resin solid or Deca-Co-10 0.07% metal on resin solids

| Dry time (h) | 1 | 2 | 3 | 4 | 5 | 6 | 7 | 8 | 9 | 10 | 11 | 12 | 13 |
|---|---|---|---|---|---|---|---|---|---|---|---|---|---|
| ST | 1 | 1 | 1 | 1 | 1 | 1 | 1 | 2 | 1 | 7 | 0.75 | 0.5 | 0.75 |
| TF | 3.5 | 2 | 2 | 2 | 2 | 6 | 10 | 9 | 6.5 | 24 | 2 | 2 | 2.5 |
| DH | 5 | 3 | 2.5 | 2.5 | 2.5 | 21.5 | 24 | 24 | 24 | 24 | 2.5 | 2.5 | 3.75 |

### Other Cross Linker Type Versus Thiol Type

Additional testing was performed to evaluate thiol-functional cross linkers with allyl, acrylate, vinyl or ene functions and compared them to the performance of the polythiol ME-4 in combination with the BOO or Cobalt driers. The formulations are given in Table 5. In Table 6, it was observed that ME-4 with BOO (2) gave better hardness than all the other cross linkers. It also gave the lowest dry time (Table 7). It was noted and interesting to see that some of the other cross-linkers such as GDA or HED helped to improve the hardness of Cobalt coatings but did not have the same effect when used with BOO. It proved that a polythiol had a more synergetic effect with BOO than the non-thiol types

TABLE 5
Formulation of Solvent borne medium oil alkyd used in combination cross linkers vs polythiols and driers.

| Sample name | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| WorléeKyd ® | 10 | 10 | 10 | 10 | 10 | 10 | 10 | 10 | 10 | 10 | 10 | 10 | 10 | 10 |
| S351 (~60% | | | | | | | | | | | | | | |
| solid) | | | | | | | | | | | | | | |
| ME-4 | | 0.3 | | | | | | | 0.3 | | | | | |
| GDA | | | 0.3 | | | | | | | 0.3 | | | | |
| DA | | | | 0.3 | | | | | | | 0.3 | | | |
| DVB | | | | | 0.3 | | | | | | | 0.3 | | |
| HED | | | | | | 0.3 | | | | | | | 0.3 | |
| TO | | | | | | | 0.3 | | | | | | | 0.3 |
| BOC | 0.06 | 0.06 | 0.06 | 0.06 | 0.06 | 0.06 | 0.06 | | | | | | | |
| Deca Co 10 | | | | | | | | 0.04 | 0.04 | 0.04 | 0.04 | 0.04 | 0.04 | 0.04 |

TABLE 6
König hardness of WorléeKyd ® S351 resin and different cross linkers vs polythiol 5% on
resin solid, using driers BOC 1% on resin solid or Deca-Co-10 0.07% metal on resin solids.

| König Hardness (s) | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| After 1 day | 14 | 26.6 | 12.6 | 15.3 | 16.8 | 15.4 | 14 | 19.6 | 5.5 | 19.6 | 20.3 | 19.5 | 21 | 13.9 |
| After 7 days | 28 | 49.1 | 23.8 | 26.6 | 26.7 | 28 | 22.5 | 40.6 | 14 | 46.3 | 43.4 | 43.5 | 50.4 | 33.6 |
| After 14 days | 36.5 | 70.1 | 35 | 33.7 | 39.2 | 36.5 | 32.2 | 56.2 | 15.4 | 66 | 60.3 | 57.5 | 67.3 | 49.1 |

TABLE 7
Dry time of WorléeKyd ® S351 resin and different cross linkers vs polythiol 5% on
resin solid, using driers BOC 1% on resin solid or Deca-Co-10 0.07% metal on resin solids

| Dry time (h) | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| ST | 1 | 1 | 1 | 1 | 1 | 1 | 1 | 1 | 1 | 1 | 1 | 1 | 0.5 | 0.5 |
| TF | 3.5 | 2 | 4.5 | 3.75 | 4 | 4.5 | 4.5 | 6 | 6.5 | 5 | 6 | 6.5 | 4 | 6 |
| DH | 5 | 2.5 | 6 | 4.5 | 4.5 | 5 | 6.5 | 21.5 | 24 | 12.5 | 13.5 | 14.5 | 11.5 | 22.5 |

Influence of Polydentate Ligands with Polythiols

In this part, TMTACN was added to Dragon, Deca Cobalt 10 and BOC, and in combinations with ME-4 (Tables 8-13). The aim was to see the influence of the ligand types with the crosslinker. The molar ratio drier: TMTACN was 1:10 (Table 11). This addition did not really change the results compared to Table 9 and Table 10. The TMTACN added alone gave a marginal approval. The crosslinker is not adversely affected by the use of additional polydentate ligands. The use of TMTACN with Dragon reduces the drytime, and here it can be shown that crosslinker does not affect the drytime or hardness of that combination—the improved hardness with crosslinker is maintained. BOC hardness is improved with the crosslinker, again no adverse effects was observed from using additional TMTACN. The cobalt has no benefit from additional TMTACN, with crosslinker there is worse performance.

TABLE 8
Formulation of polythiol with different catalyst in
WorléeKyd ® S351. Influence of catalyst choice.

| | 1 | 2 | 3 | 4 | 5 | 6 |
|---|---|---|---|---|---|---|
| WorléeKyd ® S351 | 10 | 10 | 10 | 10 | 10 | 10 |
| (~60% solid)) | | | | | | |
| ME-4 | | | | 0.3 | 0.3 | 0.3 |
| BOC | 0.06 | | | 0.06 | | |
| Deca Co 10 | | 0.042 | | | 0.042 | |
| Borchi Dragon | | | 0.06 | | | 0.06 |

TABLE 9
König hardness of WorléeKyd ® S351 using different catalysts
with or without polythiol showing the influence of catalyst choice.

| Hardness (s) | 1 | 2 | 3 | 4 | 5 | 6 |
|---|---|---|---|---|---|---|
| after 1 day | 16.8 | 21 | 18.2 | 29.5 | 9.6 | 30.9 |
| after 7 days | 25.2 | 33.6 | 22.4 | 46.2 | 12.6 | 44.8 |
| after 14 days | 26.7 | 39.4 | 24 | 53.2 | 15.4 | 53.3 |

TABLE 10
Dry time of WorléeKyd ® S351 using
different catalysts with or without polythiol.

| Dry time (h) | 1 | 2 | 3 | 4 | 5 | 6 |
|---|---|---|---|---|---|---|
| ST | 1 | 1 | 1 | 0.5 | 1 | 0.25 |
| TF | 4.5 | 2.5 | 3.5 | 1.75 | 6 | 0.75 |
| DH | 5 | 12 | 7 | 2 | 24 | 1 |

TABLE 11
Formulation of polythiol with different catalyst in WorléeKyd ® S351.
Influence of TMTACN addition (Catalyst:TMTACN = 1:10 mol/mol).

| Sample name | 1 | 2 | 3 | 4 | 5 | 6 |
|---|---|---|---|---|---|---|
| WorléeKyd | 10 | 10 | 10 | 10 | 10 | 10 |
| S351 (~60% | | | | | | |
| solid) | | | | | | |
| ME-4 | | | | 0.3 | 0.3 | 0.3 |
| BOC | 0.06 | | | 0.06 | | |
| Deca Co 10 | | 0.042 | | | 0.042 | |
| L95 (Alkyl | 0.003 | 0.005 | 0.013 | 0.003 | 0.005 | 0.013 |
| imidazoline) | | | | | | |
| Borchi Dragon | | | 0.06 | | | 0.06 |

TABLE 12
König hardness of WorléeKyd ® S351 using different
catalysts with or without polythiol showing the influence of
TMTACN addition (Catalyst:TMTACN = 1:10 mol/mol).

| Hardness (s) | 1 | 2 | 3 | 4 | 5 | 6 |
|---|---|---|---|---|---|---|
| 1 day | 15.4 | 19.6 | 18.2 | 30.9 | 11.2 | 26.6 |
| 7 days | 22.3 | 35.1 | 19.6 | 47.7 | 22.4 | 42 |
| 14 days | 26.6 | 42.1 | 21 | 53.8 | 36.4 | 49.1 |

TABLE 13
Dry time of WorléeKyd ® S351 using different catalysts
with or without polythiol showing the influence of TMTACN
addition (Catalyst:TMTACN = 1:10 mol/mol).

| Dry time (h) | 1 | 2 | 3 | 4 | 5 | 6 |
|---|---|---|---|---|---|---|
| ST | 1 | 1 | 0.5 | 0.5 | 1 | 0.25 |
| TF | 3.5 | 6.5 | 3 | 1.5 | 1.5 | 0.75 |
| DH | 4 | 20 | 4 | 1.75 | 20 | 1 |

### Amount of Polythiol Influence

It was noticed that the amount wt. % of polythiols used had an influence on the performance. As volatile polythiols have an unpleasant smell, the objective was to evaluate their efficiency at lower dosage than 5 wt. %. A ladder study from 1 to 5% was performed using ME-4 and ME-6. It was

TABLE 14
Formulation of polythiol with different amounts in WorléeKyd ® S351.

| Sample name | 1 | 2 | 3 | 4 | 5 | 6 | 7 | 8 | 9 | 10 | 11 | 12 |
|---|---|---|---|---|---|---|---|---|---|---|---|---|
| WorléeKyd S351 | 10 | 10 | 10 | 10 | 10 | 10 | 10 | 10 | 10 | 10 | 10 | 10 |
| (~60% solid) | | | | | | | | | | | | |
| ME-4 | | 0.06 | 0.12 | 0.18 | 0.24 | 0.3 | | | | | | |
| ME-6 | | | | | | | 0.06 | 0.12 | 0.18 | 0.24 | 0.3 | |
| BOC | 0.06 | 0.06 | 0.06 | 0.06 | 0.06 | 0.06 | 0.06 | 0.06 | 0.06 | 0.06 | 0.06 | |
| Deca Co 10 | | | | | | | | | | | | 0.04 |

TABLE 15
König hardness of WorléeKyd ® S351 showing the influence of amount of polythiol.

| Hardness (s) | 1 | 2 | 3 | 4 | 5 | 6 | 7 | 8 | 9 | 10 | 11 | 12 |
|---|---|---|---|---|---|---|---|---|---|---|---|---|
| after 1 day | 16.8 | 18.2 | 21.0 | 25.2 | 26.6 | 28.0 | 19.6 | 22.4 | 25.2 | 26.6 | 26.6 | 18.1 |
| after 7 days | 29.4 | 36.4 | 40.6 | 46.2 | 50.5 | 51.8 | 35 | 40.6 | 42.1 | 49.1 | 49.1 | 42 |
| after 14 days | 30.8 | 35 | 39.3 | 47.6 | 50.5 | 54.7 | 35.1 | 39.2 | 42.1 | 49 | 49.1 | 42 |

TABLE 16
Dry time of WorléeKyd ® S351 showing the influence of amount of polythiol.

| Dry time (h) | 1 | 2 | 3 | 4 | 5 | 6 | 7 | 8 | 9 | 10 | 11 | 12 |
|---|---|---|---|---|---|---|---|---|---|---|---|---|
| ST | 0.75 | 0.75 | 0.75 | 1 | 1 | 0.75 | 1 | 0.5 | 0.5 | 0.75 | 0.5 | 0.75 |
| TF | 3.75 | 2 | 2.75 | 2 | 2 | 1.75 | 4.5 | 2.5 | 2 | 1.25 | 1.75 | 5.5 |
| DH | 5.25 | 4.25 | 3.25 | 3 | 2.5 | 2 | 5.5 | 3 | 2.25 | 2.25 | 2 | 13.25 |

### Influence of the Alkyd Resin Choice.

Different solvent borne alkyd resins were tested to see the influence of the combined BOO and ME-4 addition. It seemed that this combination was more efficient with medium oil. When the oil content was around 70%, the combination did not have a big influence. However, Cobalt did not seem to have a very higher hardness with those binders either. In another study a 10 wt. % amount of ME-4 was used in Synolac 4060 but it did not help increasing the hardness either.

TABLE 17
Solvent borne alkyd description.

| | Worleekyd | Urakyd AK | Urakyd HS | Synolac | Worleekyd | Urakyd AD | Urakyd HS |
|---|---|---|---|---|---|---|---|
| | S 351, 60% | 436, 55% | 233 Q1- | 4060 WP | B 865 | 44 Q1- | 243 Q- |
| | (medium | (medium | 85, 85% | 90, 90% | nv, 65% | 70, 70% | 75, 75% |
| | oil) | oil | (long oil) | (long oil) | (long oil) | (long oil) | (long oil) |
| Oil | Soya oil | processed | Soya | Linoleic | Soya- | Soya-bean | urethane- |
| Type | | soya-bean | | rich | cotton | | modified |
| Function | Phthalic | hydroxyl | — | — | Phthalic | Phthalic | Urethane |
| | anhydride | | | | anhydride | acid 26% | |
| | 23% | | | | 22% | | |
| Oil length | 51% | 49% | 70% | 73% | 65% | 63% | Not known |

TABLE 18
Influence of alkyd resin. Formulation with BOC 1% on resin
solids or Deca-Co-10 0.07% metal on resin solids (Part 1)

| Sample Name | 1 | 2 | 3 | 4 | 5 | 6 | 7 | 8 | 9 |
|---|---|---|---|---|---|---|---|---|---|
| Worleekyd S 351, 60% | 10 | 10 | 10 | | | | | | |
| Urakyd AK 436, 55% | | | | 10 | 10 | 10 | | | |
| Urakyd HS 233 Q1-85, | | | | | | | 10 | 10 | 10 |
| 85% | | | | | | | | | |
| Synolac 4060 WP 90, | | | | | | | | | |
| 90% | | | | | | | | | |
| Worleekyd B 865 | | | | | | | | | |
| nv, 65% | | | | | | | | | |
| Urakyd AD 44 Q1-70, | | | | | | | | | |
| 70% | | | | | | | | | |
| Urakyd HS 243 Q-75, | | | | | | | | | |
| 75% | | | | | | | | | |
| Pentaerythritol | | | 0.3 | | | 0.27 | | | 0.42 |
| tetrakis(3- | | | | | | | | | |
| mercaptopropionate) | | | | | | | | | |
| BOC | 0.06 | | 0.06 | 0.05 | | 0.05 | 0.08 | | 0.08 |
| Deca Co 10 | | 0.04 | | | 0.04 | | | 0.06 | |

TABLE 19
Influence of alkyd resin. Formulation with BOC 1% on resin
solid of Deca-Co-10 0.07% metal on resin solids. (Part 2)

| Sample Name | 10 | 11 | 12 | 13 | 14 | 15 | 16 | 17 | 18 | 19 | 20 | 21 |
|---|---|---|---|---|---|---|---|---|---|---|---|---|
| Worleekyd ® S 351, 60% | 10 | 10 | 10 | | | | | | | | | |
| Urakyd AK 436, 55% | | | | 10 | 10 | 10 | | | | | | |
| Urakyd HS 233 Q1-85, | | | | | | | 10 | 10 | 10 | | | |
| 85% | | | | | | | | | | | | |
| Synolac 4060 WP 90, | | | | | | | | | | 10 | 10 | 10 |
| 90% | | | | | | | | | | | | |
| Worleekyd B 865 | | | | | | | | | | | | |
| nv, 65% | | | | | | | | | | | | |
| Urakyd AD 44 Q1-70, | | | | | | | | | | | | |
| 70% | | | | | | | | | | | | |
| Urakyd HS 243 Q-75, | | | | | | | | | | | | |
| 75% | | | | | | | | | | | | |
| Pentaerythritol | | | 0.45 | | | 0.32 | | | 0.35 | | | 0.37 |
| tetrakis(3- | | | | | | | | | | | | |
| mercaptopropionate) | | | | | | | | | | | | |
| BOC | 0.09 | | 0.09 | 0.06 | | 0.06 | 0.07 | | 0.07 | 0.07 | | 0.07 |
| Deca Co 10 | | 0.06 | | | 0.04 | | | 0.04 | | | 0.05 | |

TABLE 20
König Hardness. Influence of alkyd resin. Formulation with BOC
1% on resin solids of Deca-Co-10 0.07% metal on resin solids. (Part 1)

| Hardness (s) | | 1 | 2 | 3 | 4 | 5 | 6 | 7 | 8 | 9 | 10 | 11 | 12 |
|---|---|---|---|---|---|---|---|---|---|---|---|---|---|
| 1 | day | 13.9 | 18.1 | 28 | 19.5 | 19.6 | 29.4 | 14 | 11.2 | 12.7 | 14 | 5.6 | 12.5 |
| 7 | days | 23.8 | 33.7 | 43.4 | 33.7 | 46.3 | 54.6 | 11.2 | 8.3 | 12.6 | 11.1 | 9.8 | 12.6 |
| 14 | days | 25.2 | 40.6 | 50.5 | 42 | 51.9 | 63.1 | 9.8 | 6.9 | 12.6 | 11.2 | 8.4 | 11.2 |

TABLE 21
König Hardness. Influence of alkyd resin. Formulation with BOC
1% on resin solids of Deca-Co-10 0.07% metal on resin solids. (Part 2)

| Hardness (s) | | 13 | 14 | 15 | 16 | 17 | 18 | 19 | 20 | 21 |
|---|---|---|---|---|---|---|---|---|---|---|
| 1 | day | 12.6 | 12.5 | 21 | 9.9 | 12.5 | 14.1 | 14 | 12.6 | 12.5 |
| 7 | days | 12.6 | 21 | 28.1 | 11.2 | 15.4 | 21 | 16.8 | 21 | 21 |
| 14 | days | 14 | 19.6 | 29.5 | 11.2 | 15.4 | 21 | 18.2 | 19.6 | 22.4 |

TABLE 22
Dry time. Influence of alkyd resin. Formulation with BOC 1% on resin
solids of Deca-Co-10 0.07% metal on resin solids. (Part 1)

| Dry Time (h) | 1 | 2 | 3 | 4 | 5 | 6 | 7 | 8 | 9 | 10 | 11 | 12 |
|---|---|---|---|---|---|---|---|---|---|---|---|---|
| ST | 1 | 0.75 | 1 | 0.5 | 0.5 | 0.5 | 1.5 | 1 | 0.5 | 2 | 1.5 | 05 |
| TF | 2.5 | 5.5 | 2 | 7 | 8 | 2 | 7.5 | 7.5 | 3.5 | 12.5 | 12 | 2 |
| DH | 6 | 15.5 | 2.75 | 11 | 16 | 4 | 8.5 | 12.5 | 4.5 | 16.5 | 15.5 | 6 |

TABLE 23
Dry time. Influence of alkyd resin. Formulation with BOC 1% on resin
solids of Deca-Co-10 0.07% metal on resin solids. (Part 2)

| Dry time (h) | 13 | 14 | 15 | 16 | 17 | 18 | 19 | 20 | 21 |
|---|---|---|---|---|---|---|---|---|---|
| ST | 0.75 | 1 | 0.5 | 0.5 | 1.5 | 0.5 | 0.5 | 0.5 | 1 |
| TF | 4.5 | 5 | 1.5 | 8 | 12.5 | 1 | 12 | 3 | 5.5 |
| DH | 6.5 | 14 | 2.5 | 9.5 | 14 | 2 | 14 | 17 | 7 |

### Mixture of Polythiols.

A series of mixtures of different polythiols with BOO were evaluated. It showed that the good results obtained before were still valid when using a mixture of polythiols instead of one polythiol.

TABLE 24
Formulation with BOC 1% on resin solids or Deca-Co-10 0.07% metal on
resin solidsin WorléeKyd ® S 351. Effect of polythiol mixtures.

| Sample name | 1 | 2 | 3 | 4 | 5 |
|---|---|---|---|---|---|
| WorleeKyd ® S 351, 60% | 10 | 10 | 10 | 10 | 10 |
| ME-2 | | | | 0.1 | 0.075 |
| ME-3 | | | | | 0.075 |
| ME-4 | | | 0.15 | 0.1 | 0.075 |
| ME-6 | | | 0.15 | 0.1 | 0.075 |
| BOC | 0.06 | | 0.06 | 0.06 | 0.06 |
| Deca Co 10 | | 0.042 | | | |

TABLE 25
Konig Hardness. Effect of polythiol mixtures in
WorléeKyd ® S 351.

| Hardness (s) | 1 | 2 | 3 | 4 | 5 |
|---|---|---|---|---|---|
| 1 day | 14 | 18.2 | 22.4 | 21 | 21 |
| 7 days | 22.4 | 32.3 | 40.6 | 43.5 | 36.5 |
| 14 days | 25.2 | 40.7 | 51.9 | 49.1 | 51.9 |

TABLE 26
Dry time. Effect of polythiol mixtures in WorléeKyd ® S 351.

| Dry time (h) | 1 | 2 | 3 | 4 | 5 |
|---|---|---|---|---|---|
| ST | 1 | 1 | 0.5 | 0.5 | 0.75 |
| TF | 5.5 | 6 | 1.25 | 1.5 | 1 |
| DH | 7.5 | 11 | 1.5 | 1.75 | 1.75 |

Influence of the polythiol choice.

A Study was Conducted on the Influence of the Structure of Different Polythiols. The formulations used are described in formulation of Table 27. Apart from MeSi, DODT and DMNP, all the polythiols performed similarly than ME-4 meaning they decreased coating dry time and they increased hardness.

TABLE 27
Formulation of WorléeKyd ® S351 with different polythiols using BOC or Deca Co 10 as the drier.

| Sample name | 1 | 2 | 3 | 4 | 5 | 6 | 7 | 8 | 9 | 10 | 11 | 12 | 13 |
|---|---|---|---|---|---|---|---|---|---|---|---|---|---|
| Worleekyd ® | 10 | 10 | 10 | 10 | 10 | 5 | 10 | 10 | 10 | 10 | 5 | 10 | 10 |
| S 351, 60% | | | | | | | | | | | | | |
| ME-4 | | | 0.3 | | | | | | | | | | |
| TCA (80% | | | | 0.37 | | | | | | | | | |
| in DMSO) | | | | | | | | | | | | | |
| MESi | | | | | 0.3 | | | | | | | | |
| BDT | | | | | | 0.15 | | | | | | | |
| DODT | | | | | | | 0.3 | | | | | | |
| TMIC | | | | | | | | 0.3 | | | | | |
| DMP | | | | | | | | | 0.3 | | | | |
| AM | | | | | | | | | | 0.3 | | | |
| Silmer SH | | | | | | | | | | | | 0.3 | |
| Q20 | | | | | | | | | | | | | |
| Silmer SH | | | | | | | | | | | | | 0.3 |
| 208-30Q | | | | | | | | | | | | | |
| DMNP | | | | | | | | | | | 0.18 | | |
| (80% in | | | | | | | | | | | | | |
| DMSO) | | | | | | | | | | | | | |
| BOC | 0.06 | | 0.06 | 0.06 | 0.06 | 0.03 | 0.06 | 0.06 | 0.06 | 0.06 | 0.03 | 0.06 | 0.06 |
| Deca Co 10 | | 0.04 | | | | | | | | | | | |

TABLE 28
König hardness, influence of the polythiol in WorléeKyd ® S 351.

| Hardness (s) | | 1 | 2 | 3 | 4 | 5 | 6 | 7 | 8 | 9 | 10 | 11 | 12 | 13 |
|---|---|---|---|---|---|---|---|---|---|---|---|---|---|---|
| 1 | day | 13.9 | 16.8 | 22.4 | 22.4 | 4.1 | 21 | 14 | 23.8 | 22.4 | 16.8 | 15.4 | 28 | 28 |
| 7 | days | 22.4 | 30.9 | 44.9 | 44.8 | 26.6 | 36.4 | 28 | 37.9 | 44.9 | 28 | 26.6 | 43.4 | 40.6 |
| 14 | days | 23.8 | 42 | 49 | 39.2 | 29.5 | 46.3 | 29.5 | 43.4 | 51.9 | 40.6 | 28.1 | 46.2 | 46.3 |

TABLE 29
Dry time, influence of the polythiol in WorléeKyd ® S 351.

| Dry time (h) | 1 | 2 | 3 | 4 | 5 | 6 | 7 | 8 | 9 | 10 | 11 | 12 | 13 |
|---|---|---|---|---|---|---|---|---|---|---|---|---|---|
| ST | 0.5 | 0.75 | 0.5 | 0.5 | 1 | 0.25 | 0.5 | 0.5 | 0.5 | 0.5 | 0.5 | 0.5 | 0.75 |
| TF | 4 | 5 | 1 | 3.5 | 10 | 0.75 | 4.5 | 1.5 | 2.5 | 5.5 | 3 | 2 | 1.5 |
| HD | 5.75 | 11.75 | 1.5 | 4.25 | 22 | 1.5 | 5.5 | 2 | 3 | 11.5 | 7.5 | 4.25 | 5 |

### Formulated Pigmented System.

The formulations in Table 34 and Table 35 were used to determine the effect of a pigmented system on the performances of ME-4/BOC combination. SH groups interacted with the titanium dioxide pigment, which could suggest some chelation via the thiol groups. In some cases, a destabilisation of the pigment dispersion was observed. Regardless, in Tables 33-38, it was seen that the addition of ME-4/BOC still improved hardness and decreased dry time. Here, the dosage of BOC, Deca Co 10 and ME-4 was based on total formulation and not on resin solids.

TABLE 30
Formulation for white pigment concentrate used
in Synolac 4060 WDA 90 and Uralac HS 233.

| Chemical name | Mass (g) |
|---|---|
| MPA | 31.5 |
| BGen 1252 | 3 |
| Aerosil R972 | 0.5 |
| Kronos 2360 | 65 |
| Total | 100 |

TABLE 31
Formulation for white coating using
Synolac 4060 WDA 90 as alkyd binder.

| Synolac 4060 WDA 90 white coat: | |
|---|---|
| Chemical name | Mass (g) |
| Synolac 4060 WDA 90 | 14.9 |
| BGen 1252 | 0.07 |
| Kronos 2190 | 34.78 |
| Exxol D 60 | 5 |
| Disperse at high speed 5000-7000 rpm approx. 30 min, then add | |
| while stirring | |
| Synolac 4060 WDA 90 | 36.67 |
| Exxol D 60 | 8.58 |
| Total: | 100 |

TABLE 32
Formulation for white coating using
Synolac 4060 WDA 90 as alkyd binder.

| Uralac HS 233 white coat | |
|---|---|
| Chemical name | Mass (g) |
| Uralac HS 233 Q1-85 | 57.5 |
| D 60 | 4.5 |
| PC white based on Kronos 2360 | 38 |
| Total | 100 |

TABLE 33
Formulation Synolac 4060 WDA 90 white formulation.

| Samples | 1 | 2 | 3 |
|---|---|---|---|
| Synolac 4060 WDA 90 | 28 | 28 | 28 |
| white coat formulation | | | |
| ME-4 | | 1.4 | |
| BOC | 0.065 | 0.065 | |
| Deca Co 10 | | | 0.196 |

TABLE 34
König hardness in Synolac 4060 WDA 90 white formulation.

| Sample name | 1 | 2 | 3 |
|---|---|---|---|
| After 14 days | 12.7 | 19.7 | 18.3 |

TABLE 35
Dry time of Synolac 4060 WDA 90 white formulation.

| Samples | 1 | 2 | 3 |
|---|---|---|---|
| ST | 2.5 | 0.5 | 1.5 |
| TF | 4.5 | 1 | 17 |
| DH | 13.5 | 3.5 | 20 |

TABLE 36
Formulation Uralac HS 233 white formulation

| Samples | 4 | 5 | 6 |
|---|---|---|---|
| Uralac HS 233 test | 28 | 28 | 28 |
| white coat formulation | | | |
| ME-4 | | 1.4 | |
| BOC | 0.065 | 0.065 | |
| Deca Co 10 | | | 0.196 |

TABLE 37
König hardness in Uralac HS 233 white formulation.

| Sample name | 4 | 5 | 6 |
|---|---|---|---|
| After 14 days | 14 | 18.1 | 9.8 |

TABLE 38
Dry time of Uralac HS 233 white formulation.

| Sample name | 4 | 5 | 6 |
|---|---|---|---|
| ST | 0.5 | 0.25 | 0.25 |
| TF | 8.5 | 1 | 5 |
| DH | 10 | 1.75 | 13 |

### Effect of Anti-Skinning Agent.

Anti-skinning agent 445 was used at 0.6, 0.9 and 1.2%, based on the total formulation weight, with BOO or the BOC/ME-4 combination see Table 39. In Table 40, it could be seen that the addition of anti-skinning agent can prevent skinning whilst not affecting the hardness improvement brought by using the BOC/ME-4 combination. The dry time of BOC/ME-4 was still faster even with a high loading of antiskinning agent (Table 41). For blends 1,2 and 3 the dry time was highly impacted depending on the amount of 445 used.

TABLE 39
Formulation of Worléekyd S351 with anti-skinning
agent and BOC/ME-4 compared with Deca Co 10.

| Sample name | 1 | 2 | 3 | 4 | 5 | 6 |
|---|---|---|---|---|---|---|
| Worleekyd ® | 10 | 10 | 10 | 10 | 10 | 10 |
| S 351 (60%) | | | | | | |
| ME-4 | | | | 0.3 | 0.3 | 0.3 |
| BOC | 0.06 | 0.06 | 0.06 | 0.06 | 0.06 | 0.06 |
| 445 | 0.060 | 0.090 | 0.12 | 0.062 | 0.093 | 0.12 |
| Appearance | No | No | No | Skin | Soft | No |
| | skin | skin | skin | | skin | skin |

TABLE 40
König hardness of Worléekyd S351 with
anti-skinning agent and BOC/ME-4 compared with Deca Co 10.

| Sample name | 1 | 2 | 3 | 4 | 5 | 6 |
|---|---|---|---|---|---|---|
| After 1 day | 8.4 | 4.1 | 2.7 | 18.1 | 19.6 | 18.2 |
| After 7 days | 22.4 | 22.4 | 25.2 | 40.7 | 44.8 | 42.1 |

TABLE 41
Dry time of Worléekyd S351 with anti-skinning
agent and BOC/ME-4 compared with Deca Co 10.

| Sample name | 1 | 2 | 3 | 4 | 5 | 6 |
|---|---|---|---|---|---|---|
| ST | 1.5 | 1.5 | 1.5 | 1 | 1.5 | 1 |
| TF | 15 | 17 | 18.75 | 6 | 6.5 | 7 |
| DH | 16 | 20 | 22.5 | 7 | 7 | 7.5 |

To perform scratch tests, a pigmented formulation was made (Tables 42-43) and combined with BOO, Deca Co 10 or BOC/ME-4 (Table 44). These formulations were then coated on metal panels using a 100 pim thickness film applicator. Prior adhesion and scratch test, the panels were placed 1 hour at 10000 to ensure complete curing of the coating. The cured panels were then placed 48 hours in the climate-controlled room (2300, 50% humidity) before the scratch test. In Table 46, it could seen that the OW for BOC/ME-4 was the highest suggesting the coating was harder to scratch than BOO or Deca Co 10.

TABLE 42
PC RED Pigment concentrate formulation and grinding process

| | |
|---|---|
| MPA | 31.2 |
| BGen 0755 | 3.3 |
| Aerosil R 972 | 0.5 |
| Bayferrox 130M | 65 |
| Total | 100 |

Grinding process

| | |
|---|---|
| Grinding: | Scandex/Lau |
| Glass beads: | 1:1.5 |
| Cooling: | 1 |
| Grind time | 1 hour |

TABLE 43
Formulation with Synolac 4060 WP 90:TF1.

| | |
|---|---|
| Synolac 4060 WP 90 | 60.54 |
| Exxol D 60 | 19.46 |
| PC RED | 20 |
| Total | 100 |

TABLE 44
Formulation TF1 and PC RED in combination
with BOC, Deca Co 10 or BOC/ME-4.

| Sample name | 1 | 2 | 3 |
|---|---|---|---|
| TF1 | 10 | 10 | 10 |
| BOC | 0.046 | 0.054 | |
| ME-4 | | 0.27 | |
| Deca Co 10 | | | 0.038 |

TABLE 45
König hardness TF1 and drier

| Hardness | 1 | 2 | 3 |
|---|---|---|---|
| 1 day | 15.4 | 23.8 | 16.7 |
| 1 hour at 100° C. | 28 | 60.3 | 30.8 |

TABLE 46
Critical weight = weight no scratch

| Sample name | 1 | 2 | 3 |
|---|---|---|---|
| Film thickness (μm) | 35.7 | 38.5 | 35.2 |
| Critical weight (CW) | 200 g | 400 g | 200 g |

### Pre-Prepared Thiol BOC Blend

A pre-prepared mixture of thiol crosslinker and primary drier would be easier for a formulator to use, it was therefore compared the performance of a pre-blended combination versus adding the individual components. Different blends of BOO and ME-4 were prepared using MPA, Ethylal or DBE-5 solvents (Table 47). Those blends were stored one week at ambient temperature prior being tested in Worléekyd S351 resin to check their stability storage overtime. After one week storage, those blends were used in combination with Worléekyd® S351 (Table 48) and the hardness and the dry time were evaluated (Tables 49 and 50). All the blends showed a higher hardness and lower dry time than BOO (sample 0) used alone. The performance was maintained regardless of supply form, meaning that the components were compatible and could easily mixed for ease of application versus adding separate components

TABLE 47
Blends of BOC/ME-4 and solvents

| | Mix 1 | Mix 2 | Mix 3 |
|---|---|---|---|
| BOC | 0.6 | 0.3 | 0.3 |
| ME-4 | 3 | 1.5 | 1.5 |
| MPA | 0.9 | | |
| Ethylal | | 1.8 | |
| DBE-5 | | | 1.8 |
| Appearance 24 hours | clear | clear stable | clear yellow |
| after mixing | yellow | yellow | stable |

TABLE 48
Formulation of blends BOC/ME-4 with Worléekyd S351

| Sample name | 0 | 1 | 2 | 3 |
|---|---|---|---|---|
| Worleekyd ® S351 | 10 | 10 | 10 | 10 |
| (~60% solid) | | | | |
| Mix 1 | | 0.45 | | |
| Mix 2 | | | 0.72 | |
| Mix 3 | | | | 0.72 |
| BOC | 0.06 | | | |

TABLE 49
Hardness values in Worléekyd ® S351 using
pre-mixed drier blends of BOC/ME-4 and solvents

| Sample name | 0 | 1 | 2 | 3 |
|---|---|---|---|---|
| 1 day | 18 | 22.4 | 28 | 28 |
| 7 days | 28 | 42.1 | 49.1 | 49 |
| 14 days | 33 | 49.1 | 58.9 | 57.5 |

TABLE 50
Dry time in Worléekyd ® S351 using
pre-mixed drier blends of BOC/ME-4 and solvents

| Sample name | 0 | 1 | 2 | 3 |
|---|---|---|---|---|
| ST | 1 | 0.5 | 0.5 | 1 |
| TF | 4.5 | 1.5 | 1.5 | 1.75 |
| DH | 5 | 1.75 | 1.75 | 2.5 |

In the following further embodiments are disclosed:

In a first embodiment a process for improving the hardness of an alkyd resin comprising the following steps, without regard to order, of: adding at least one metal ligand complex wherein the metal is selected from the group consisting of Fe, V, Cu and Mn; and adding at least one ligand selected from the group consisting of Bispidon, N4py type, TACN-type, Cyclam and cross-bridged ligands, and Trispicen-type ligands in either a preformed metal ligand complex of the metal and the ligand or formed in-situ as the metal ligand complex; and adding at least one thiol or polythiol, said thiol or polythiol comprising up to 10% by weight on resin solids; and at least 25% thiol group content by weight of thiol.

In a second embodiment of the process of the first embodiment the ligand is a bispidon ligand of Formula (I)

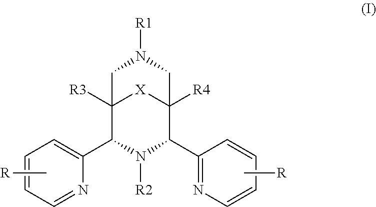

wherein
each R is independently selected from the group consisting of hydrogen, F, Cl, Br, hydroxyl, C₁₋₄-alkylO—, —NH—CO—H, —NH—CO—C₁₋₄ alkyl, —NH₂, —NH—C₁₋₄ alkyl, and C₁₋₄ alkyl;
R1 and R2 are independently selected from the group consisting of C₁₋₂₄-alkyl, C₆₋₁₀-aryl, and a group containing one or two heteroatoms (e.g. N, O or S) capable of coordinating to a transition metal;
R3 and R4 are independently selected from the group consisting of hydrogen, C₁₋₈-alkyl, C₁₋₈-alkyl-O—C₁₋₈alkyl, C₁₋₈-alkyl-O—C₆₋₁₀-aryl, C₆₋₁₀-aryl, C₁₋₈-hydroxyalkyl and —(CH₂)ₙC(O)OR5 wherein R5 is independently selected from hydrogen and C₁₋₄-alkyl,
n is from 0 to 4
X is selected from the group consisting of C═O, —[C(R6)₂]_{y}— wherein y is from 0 to 3; and
each R6 is independently selected from the group consisting of hydrogen, hydroxyl, C₁₋₄ alkoxy and C₁₋₄ alkyl.

In a third embodiment of the process of the first embodiment the ligand is a N4py-type ligand of Formula (II)

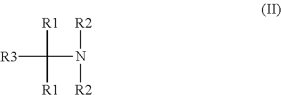

wherein:
each R1 and R2 independently represents —R4—R5;
R3 represents hydrogen, C₁₋₈-alkyl, aryl selected from homoaromatic compounds having a molecular weight under 300, or C₇₋₄₀-arylalkyl, or —R4—R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

In a fourth embodiment of the process of the first embodiment the ligand is a TACN-type ligand of Formula (III)

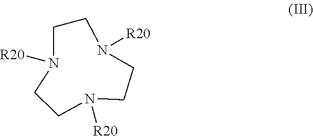

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺ (R21)₃,
R21 is selected from hydrogen, C₁₋₃-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₃-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and wherein at least one of R20 is a —CY₂—R22.

In a fifth embodiment of the process of the first embodiment the ligand is a cyclam or cross-bridged ligand of Formula (IV)

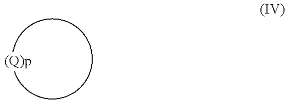

wherein
Q is independently selected from

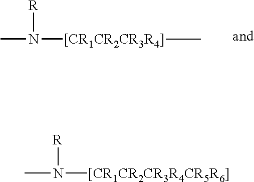

p is 4;
R is independently selected from: hydrogen, C₁₋₆-alkyl, CH₂CH₂OH, pyridin-2-ylmethyl, and CH₂COOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy.

In a sixth embodiment of the process of the fifth embodiment the cross-bridged ligand is of the formula (V):

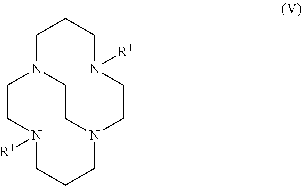

wherein
R¹ is independently selected from H, C₁₋₂₀alkyl, C₇₋₄₀-alkylaryl, C₂₋₆-alkenyl or C₂₋₆-alkynyl.

In a seventh embodiment of the process of the first embodiment the ligand is a trispicen-type ligand formula (VI):

$$R 17 R 17 N - X - NR 17 R 17 , \qquad ( VI )$$

wherein:
X is selected from —CH₂CH₂—, —CH₂CH₂CH₂—, —CH₂C(OH)HCH₂—;
each R17 independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀-arylalkyl groups optionally substituted with a substituent selected from hydroxy, alkoxy, phenoxy, carboxylate, carboxamide, carboxylic ester, sulfonate, amine, alkylamine and N⁺ (R19)₃, wherein
R19 is selected from hydrogen, C₁₋₃-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇; and
R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.

In an eighth embodiment of the process of the second embodiment the bispidon ligand is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1)

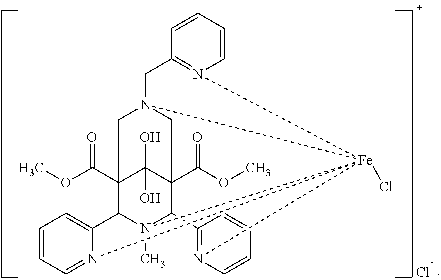

In a ninth embodiment of the process of the first embodiment the metal-ligand complex is a combination blend of: a 1,4,7-trimethyl-1,4,7-triazonane; and a metal carboxylate a ratio of 1,4,7-trimethyl-1,4,7-triazonane to metal carboxylate ranging from 0.001 to 1,000/1 inclusive.

In a tenth embodiment of the process of the first embodiment the at least one thiol or polythiol is wherein

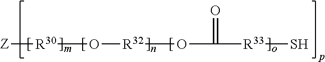

Z is a covalently bonding bridging moiety;
R³⁰ is independently selected from the group consisting of a C₁₋₃₀ branched or straight chain alkyl; C₁₋₃₀ branched or straight chain alkenyl, C₅₋₄₅ cycloalkyl, C₅₋₄₅-cycloalkenyl, C₆₋₄₅-aryl, C₆₋₄₅-arylalkyl, C₆₋₄₅-alkylaryl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and
R³⁰ or Z may comprise a heteroatom link based on O, N, S, P or terminal groups based on those heteroatoms and further wherein the heteroatom link may contain an epoxy group or a siloxane or a polysiloxane group including branched or linear equivalents, that can also contain additional functionality which includes an acrylate, unsaturated carbon-carbon bonds, alcohol or acid groups, and still further wherein the crosslinker can be a silicone-thiol resin and wherein R³⁰ or Z groups can be an alcohol functionality and further wherein the thiol or polythiol may further comprise an acrylic or polyacrylic groups that may have comonomers or monomers with functionality comprising free allyl groups, free thiol groups, unsaturated carbon-carbon-bonds including the use of ethylene glycol dimethacrylate, or alcohol groups incorporated by the use of hydroxyethylmethacrylate, or acids from acrylic acid, or epoxy groups further comprising polymeric crosslinkers derived from polyurethanes and polyesters,
R³² and R³³ are selected from the group identified for R³⁰;
m, n, and o are independently 0 or 1; and
p is an integral value from 1 to 10, preferably is an integral value from 3 to 6;
and wherein the siloxane or polysiloxane is linear or branched polymer or derivatized polymer with acetoxy, oxime, amine, or alkoxy substituents having a weight average (M_{w}) molecular weight of between 200 and 50,000 inclusive, and may further comprise a copolymers thereof including copolymers of polypropylene oxide and polyethylene oxide:

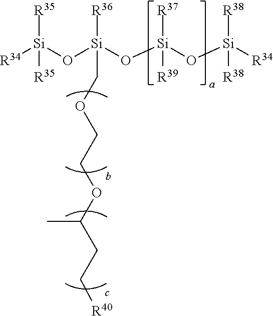

and wherein
R³⁴ to R⁴⁰ are independently selected from the group for R³⁰ above; and a, b, and c are independently selected from 0 to 3,000 inclusive.

In an eleventh embodiment of the process of the tenth embodiment the at least one thiol or polythiol is selected from the group consisting of
(A) ethylene bis(thioglycolate)

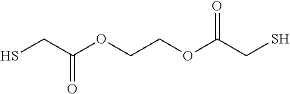 [SMILES: O=C(CS)OCCOC(=O)CS]

(B) trimethylolpropane tris(3-mercaptopropionate)

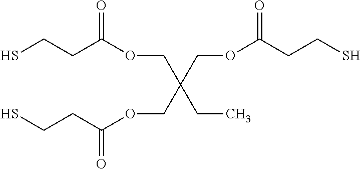 [SMILES: CCC(COC(=O)CCS)(COC(=O)CCS)COC(=O)CCS]

(C) pentaerythritol tetrakis(3-mercaptopropionate)

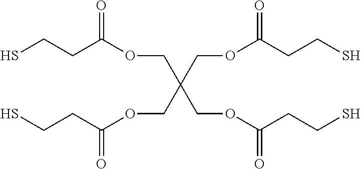 [SMILES: O=C(CCS)OCC(COC(=O)CCS)(COC(=O)CCS)COC(=O)CCS]

(D) dipentaerythritol hexakis(3-mercaptopropionate)

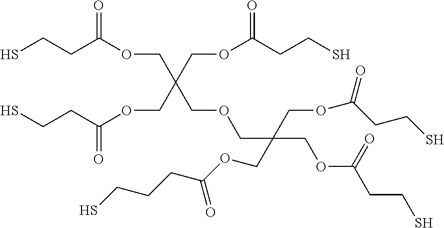 [SMILES: O=C(CCS)OCC(COCC(COC(=O)CCS)(COC(=O)CCS)COC(=O)CCCS)(COC(=O)CCS)COC(=O)CCS]

(E) a mercaptoalkionate

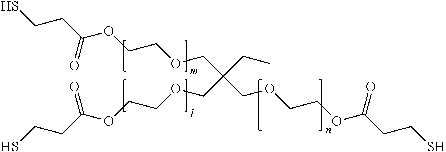

wherein the molecular weight of segments for l+m+n being adjusted so that the weight average (M_{w}) MW totals to ˜500-2000 and wherein l+m+n independently total to a range between ˜10-40.

In a twelfth embodiment the process of the first embodiment further comprises the step of: adding at least one metal ligand complex and at least one thiol or polythiol to an alkyd-based paint formulation, an alkyd-based ink formulation or a composite or gel coating formulation based on unsaturated polyester resin, styrene or acrylate monomers, or vinyl ester resin; and/or which further comprises the step of: pre-combining the at least one metal ligand complex with the at least one thiol or polythiol prior to addition to the alkyd-based paint formulation; and/or wherein the step of adding the at least one thiol or polythiol to a resin occurs before the step of adding the metal ligand complex, and/or which further comprises at least one additional step selected from the group consisting of adding at least one antiskinning compound; adding one or more auxiliary driers or secondary driers; adding at least one UV stabilizer; adding at least one dispersant; adding at least one surfactant; adding at least one corrosion-inhibitor; adding at least one filler; adding at least one antistatic agent; adding at least one flame-retardant; adding at least one lubricant; adding at least one antifoaming agent; adding at least one antifouling agent; adding at least one bactericides; adding at least one fungicide; adding at least one algaecide; adding at least one insecticide; adding at least one extender; adding at least one plasticizer; adding at least one antifreezing agent; adding at least one wax; adding at least one thickener; and adding at least one pigment.

In a thirteenth embodiment a coating composition comprises: at least one metal wherein the metal is selected from the group consisting of Fe, V, Cu and Mn; and at least one ligand selected from the group consisting of Bispidon, N4py type, TACN-type, Cyclam and cross-bridged ligands, and Trispicen-type ligands, said ligands added as an in-situ complex or as a pre-made complex with the at least one metal; and at least one thiol or polythiol, said thiol or polythiol comprising at least 15% thiol group content by weight of the thiol, preferably wherein the at least one thiol or polythiol has at least 25% thiol group content by weight of the thiol.

In a fourteenth embodiment of the coating composition of the thirteenth embodiment the at least one ligand is selected from the group consisting of:
(A) the bispidon ligand of Formula (I)

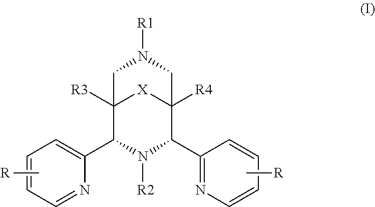

wherein:
   each R is independently selected from the group consisting of hydrogen, F, Cl, Br, hydroxyl, C₁₋₄-alkylO—, —NH—CO—H, —NH—CO—C₁₋₄-alkyl, —NH₂, —NH—C₁₋₄-alkyl, and C₁₋₄-alkyl;
   R1 and R2 are independently selected from the group consisting of C₁₋₂₄-alkyl, C₆₋₁₀-aryl, and a group containing one or two heteroatoms (e.g. N, O or S) capable of coordinating to a transition metal;
   R3 and R4 are independently selected from the group consisting of hydrogen, C₁₋₈-alkyl, C₁₋₈-alkyl-O—C₁₋₈-alkyl, C₁₋₈-alkyl-O—C₆₋₁₀-aryl, C₆₋₁₀-aryl, C₁₋₈-hydroxyalkyl and —(CH₂)ₙC(O)OR5 wherein R5 is independently selected from hydrogen and C₁₋₄-alkyl,
   n is from 0 to 4
   X is selected from the group consisting of C=O, —[C(R6)₂]_{y}— wherein y is from 0 to 3; and
   each R6 is independently selected from the group consisting of hydrogen, hydroxyl, C₁₋₄-alkoxy and C₁₋₄-alkyl
(B) the N4py-type ligand of Formula (II)

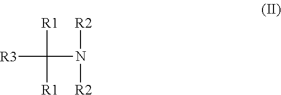

wherein:
   each R1 and R2 independently represents —R4—R5;
   R3 represents hydrogen, C₁₋₈-alkyl, aryl selected from homoaromatic compounds having a molecular weight under 300, or C₇₋₄₀-arylalkyl, or —R4—R5,
   each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
   each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl
(C) the TACN-type ligand of Formula (III)

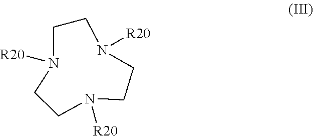

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺ (R21)₃,
R21 is selected from hydrogen, C₁₋₃-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₃-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
   wherein at least one of R20 is a —CY₂—R22
(D) the cyclam or cross-bridged ligand of Formula (IV)

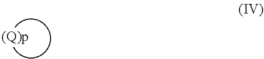

wherein:
Q is independently selected from
p is 4;

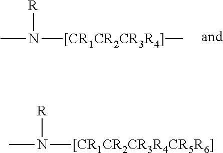

R is independently selected from: hydrogen, C₁₋₆-alkyl, CH₂CH₂OH, pyridin-2-ylmethyl, and CH₂OOOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy
(E) the cross-bridged ligand of the formula (V):

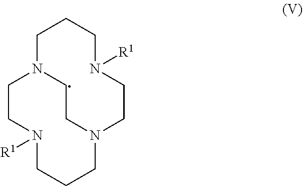

wherein
R¹ is independently selected from H, C₁₋₂₀-alkyl, C₇₋₄₀-alkylaryl, C₂₋₆-alkenyl or C₂₋₆-alkynyl
(F) the ligand is a trispicen-type ligand formula (VI):

$$R 17 R 17 N - X - NR 17 R 17 , \qquad ( VI )$$

wherein:
   X is selected from —CH₂CH₂—, —CH₂CH₂CH₂—, —CH₂C(OH)HCH₂—;
   each R17 independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺ (R19)₃, wherein
   R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18,
   and/or wherein the at least one thiol or polythiol is selected from the group consisting of:
at least one thiol or polythiol is

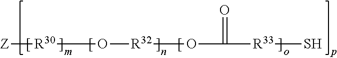

wherein
Z is a covalently bonding bridging moiety;
R³⁰ is independently selected from the group consisting of a C₁₋₃₀ branched or straight chain alkyl; C₁₋₃₀ branched or straight chain alkenyl, C₅₋₄₅-cycloalkyl, C₅₋₄₅-cycloalkenyl, C₆₋₄₅-aryl, C₆₋₄₅-arylalkyl, C₆₋₄₅-alkylaryl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and
R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, and further wherein the heteroaryl may be connected to the heteroaryl via any atom in the ring of the selected heteroaryl;
the heteroatom link being based on O, N, S, P or terminal groups based on those heteroatoms; epoxy groups; a siloxane or polysiloxane group including branched or linear equivalents, the siloxane or polysiloxane containing additional functionality such as an acrylate, unsaturated carbon-carbon bonds, alcohol or acid groups; alcohol functionality, acrylic or polyacrylic groups that may have comonomers or monomers with functionality comprising free allyl groups, unsaturated carbon-carbon-bonds or alcohol groups incorporated by use of acrylate functionality, carboxylic acid functionality or epoxy groups;
R³² and R³³ are selected from the group identified for R³⁰;
m, n, o are either 0 or 1;
p is an integral value from 1 to 10; and wherein
the siloxane or polysiloxane is linear or branched polymer or derivatized polymer with acetoxy, oxime, amine, or alkoxy substituents having a weight average (M_{w}) molecular weight of between 200-50,000 inclusive.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process for improving the hardness of an alkyd resin comprising the following steps, without regard to order, of:
adding at least one metal ligand complex wherein the metal is selected from the group consisting of Fe, V, Cu and Mn; and
adding at least one ligand selected from the group consisting of Bispidon, N4py-type, TACN-type, Cyclam and cross-bridged ligands, and Trispicen-type ligands in either a preformed metal ligand complex of the metal and the ligand or formed in-situ as the metal ligand complex; and
adding at least one thiol or polythiol, said thiol or polythiol comprising up to 10% by weight on resin solids; and
at least 25% thiol group content by weight of thiol, wherein
the Bispidon ligand is a ligand of Formula (I) 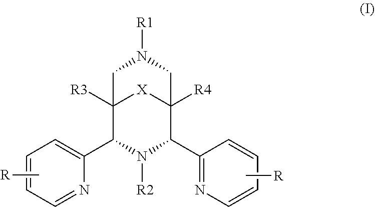
wherein:
each R is independently selected from the group consisting of hydrogen, F, Cl, Br, hydroxyl, C₁₋₄-alkylO—, —NH—CO—H, —NH—CO—C₁₋₄-alkyl, —NH₂, —NH—C₁₋₄-alkyl, and C₁₋₄-alkyl;
R1 and R2 are independently selected from the group consisting of C₁₋₂₄-alkyl, C₆₋₁₀-aryl, and a group containing one or two heteroatoms (e.g. N, O or S) capable of coordinating to a transition metal;
R3 and R4 are independently selected from the group consisting of hydrogen, C₁₋₈-alkyl, C₁₋₈-alkyl-O—C₁₋₈-alkyl, C₁₋₈-alkyl-O—C₆₋₁₀-aryl, C₆₋₁₀-aryl, C₁₋₈-hydroxyalkyl and —(CH₂)ₙC(O)OR5 wherein R5 is independently selected from hydrogen and C₁₋₄-alkyl,
n is from 0 to 4
X is selected from the group consisting of C=O, —[C(R6)₂]_{y}—wherein y is from 0 to 3; and
each R6 is independently selected from the group consisting of hydrogen, hydroxyl, C₁₋₄-alkoxy and C₁₋₄-alkyl,
wherein
the N4py-type ligand is a ligand of Formula (II) 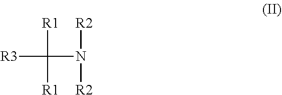
wherein:
each R1 and R2 independently represents —R4—R5;
R3 represents hydrogen, C₁₋₈-alkyl, aryl selected from homoaromatic compounds having a molecular weight under 300, or C₇₋₄₀-arylalkyl, or —R4—R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl,
wherein
the TACN-type ligand is a ligand of Formula (III) 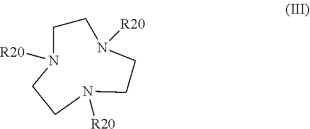
wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclo-nonanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺ (R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
wherein at least one of R20 is a —CY₂—R22, wherein
the Cyclam or cross-bridged ligand is a ligand of Formula (IV) 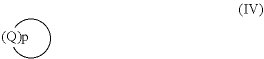
wherein:
Q is independently selected from 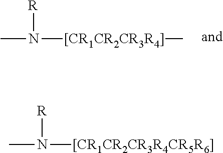
p is 4;
R is independently selected from: hydrogen, C₁₋₆-alkyl, CH₂CH₂OH, pyridin-2-ylmethyl, and CH₂COOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy,
wherein the Trispicen-type ligand is a ligand of formula (VI):
$$R 17 R 17 N - X - NR 17 R 17 , \qquad ( VI )$$
wherein:
X is selected from —CH₂CH₂—, —CH₂CH₂CH₂—, —CH₂C(OH)HCH₂—;
each R17 independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triaza-cyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraaza cyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀-arylalkyl groups optionally substituted with a substituent selected from hydroxy, alkoxy, phenoxy, carboxylate, carboxamide, carboxylic ester, sulfonate, amine, alkylamine and N⁺ (R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇; and
R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.

2. The process of claim 1 wherein the cross-bridged ligand is of the formula (V): 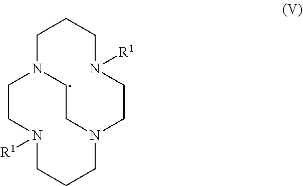
wherein
R¹ is independently selected from H, C₁₋₂₀ alkyl, C₇₋₄₀-alkylaryl, C₂₋₆-alkenyl or C₂₋₆-alkynyl.

3. The process of claim 1 wherein
the Bispidon ligand is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1)

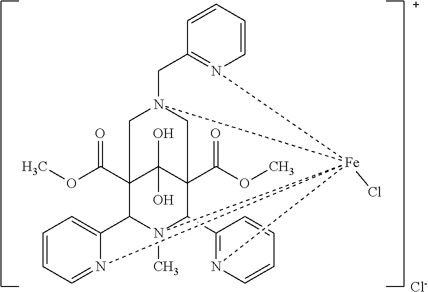

4. The process of claim 1 wherein
the metal-ligand complex is a combination blend of:
a 1,4,7-trimethyl-1,4,7-triazonane; and
a metal carboxylate
a ratio of 1,4,7-trimethyl-1,4,7-triazonane to metal carboxylate ranging from 0.001 to 1,000/1 inclusive.

5. The process of claim 1 wherein the
at least one thiol or polythiol is 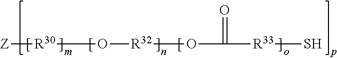
wherein
Z is a covalently bonding bridging moiety;
R³⁰ is independently selected from the group consisting of a C₁₋₃₀ branched or straight chain alkyl; C₁₋₃₀ branched or straight chain alkenyl, C₅₋₄₅-cycloalkyl, C₅₋₄₅-cycloalkenyl, C₆₋₄₅-aryl, C₆₋₄₅-arylalkyl, C₆₋₄₅-alkylaryl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and
R30 or Z may comprise a heteroatom link based on O, N, S, P or terminal groups based on those heteroatoms and further wherein the heteroatom link may contain an epoxy group or a siloxane or a polysiloxane group including branched or linear equivalents, that can also contain additional functionality which includes an acrylate, unsaturated carbon-carbon bonds, alcohol or acid groups, and still further wherein the crosslinker can be a silicone-thiol resin and wherein R³⁰ or Z groups can be an alcohol functionality and further wherein the thiol or polythiol may further comprise an acrylic or polyacrylic groups that may have comonomers or monomers with functionality comprising free allyl groups, free thiol groups, unsaturated carbon-carbon-bonds including the use of ethylene glycol dimethacrylate, or alcohol groups incorporated by the use of hydroxyethylmethacrylate, or acids from acrylic acid, or epoxy groups further comprising polymeric crosslinkers derived from polyurethanes and polyesters,
R³² and R³³ are selected from the group identified for R³⁰
m, n, and o are independently 0 or 1; and
p is an integral value from 1 to 10, preferably is an integral value from 3 to 6;
and wherein the siloxane or polysiloxane is linear or branched polymer or derivatized polymer with acetoxy, oxime, amine, or alkoxy substituents having a weight average (M_{w}) molecular weight of between 200 and 50,000 inclusive, and may further comprise a copolymers thereof including copolymers of polypropylene oxide and polyethylene oxide: 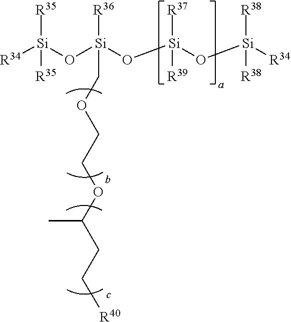
and wherein
R³⁴ to R⁴⁰ are independently selected from the group for R³⁰ above; and
a, b, and c are independently selected from 0 to 3,000 inclusive.

6. The process of claim 5 wherein
the at least one thiol or polythiol is selected from the group consisting of (F) ethylene bis(thioglycolate) 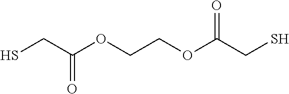 [SMILES: O=C(CS)OCCOC(=O)CS]
(G) trimethylolpropane tris(3-mercaptopropionate) 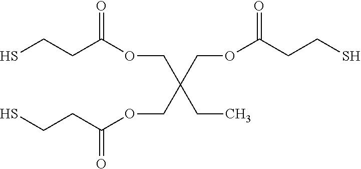 [SMILES: CCC(COC(=O)CCS)(COC(=O)CCS)COC(=O)CCS]
(H) pentaerythritol tetrakis(3-mercaptopropionate) 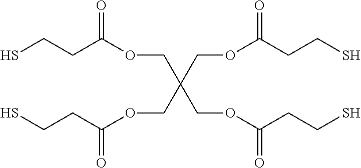 [SMILES: O=C(CCS)OCC(COC(=O)CCS)(COC(=O)CCS)COC(=O)CCS]
(I) dipentaerythritol hexakis(3-mercaptopropionate) 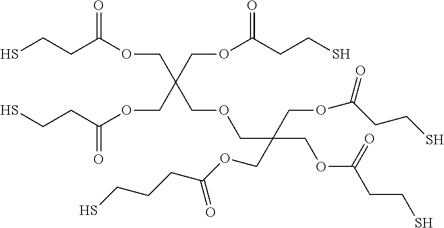 [SMILES: O=C(CCS)OCC(COCC(COC(=O)CCS)(COC(=O)CCS)COC(=O)CCCS)(COC(=O)CCS)COC(=O)CCS]
(J) a mercaptoalkionate 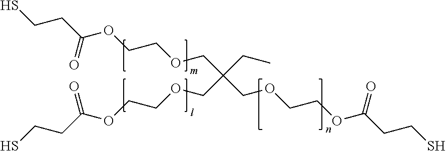
wherein the molecular weight of segments for l+m+n being adjusted so that the weight average (M_{w}) molecular weight totals to ˜500-2000 and wherein l+m+n independently total to a range between ˜10-40.

7. A product produced by the process of claim 6.

8. The process of claim 1 which further comprises the step of:
adding at least one metal ligand complex and at least one thiol or polythiol to an alkyd-based paint formulation, an alkyd-based ink formulation or a composite or gel coating formulation based on unsaturated polyester resin, styrene or acrylate monomers, or vinyl ester resin;
and/or
which further comprises the step of:
pre-combining the at least one metal ligand complex with the at least one thiol or polythiol prior to addition to the alkyd-based paint formulation;
and/or wherein the step of adding the at least one thiol or polythiol to a resin occurs before the step of adding the metal ligand complex,
and/or which further comprises at least one additional step selected from the group consisting of
adding at least one antiskinning compound;
adding one or more auxiliary driers or secondary driers;
adding at least one UV stabilizer;
adding at least one dispersant;
adding at least one surfactant;
adding at least one corrosion-inhibitor;
adding at least one filler;
adding at least one antistatic agent;
adding at least one flame-retardant;
adding at least one lubricant;
adding at least one antifoaming agent;
adding at least one antifouling agent;
adding at least one bactericides;
adding at least one fungicide;
adding at least one algaecide;
adding at least one insecticide;
adding at least one extender;
adding at least one plasticizer;
adding at least one antifreezing agent;
adding at least one wax;
adding at least one thickener; and
adding at least one pigment.

9. A coating composition which comprises:
at least one metal wherein the metal is selected from the group consisting of Fe, V, Cu and Mn; and
at least one ligand selected from the group consisting of Bispidon, N4py type, TACN-type, Cyclam and cross-bridged ligands, and Trispicen-type ligands, said ligands added as an in-situ complex or as a pre-made complex with the at least one metal; and
at least one thiol or polythiol, said thiol or polythiol comprising
at least 15% thiol group content by weight of the thiol
preferably wherein the at least one thiol or polythiol has at least 25% thiol group content by weight of the thiol, wherein:
(A) the Bispidon ligand is a ligand of Formula (I) 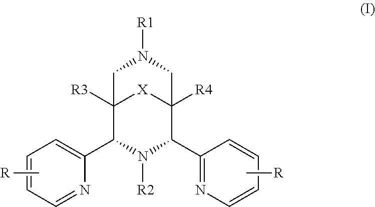
wherein:
each R is independently selected from the group consisting of hydrogen, F, Cl, Br, hydroxyl, C₁₋₄-alkylO—, —NH—CO—H, —NH—CO—C₁₋₄-alkyl, —NH₂, —NH—C₁₋₄-alkyl, and C₁₋₄-alkyl;
R1 and R2 are independently selected from the group consisting of C₁₋₂₄-alkyl, C₆₋₁₀-aryl, and a group containing one or two heteroatoms (e.g. N, O or S) capable of coordinating to a transition metal;
R3 and R4 are independently selected from the group consisting of hydrogen, C₁₋₈-alkyl, C₁₋₈-alkyl-O—C₁₋₈-alkyl, C₁₋₈-alkyl-O—C₆₋₁₀-aryl,
C₆₋₁₀-aryl, C₁₋₈-hydroxyalkyl and —(CH₂)ₙC(O)OR5 wherein R5 is independently selected from hydrogen and C₁₋₄-alkyl,
n is from 0 to 4
X is selected from the group consisting of C=O, —[C(R6)₂]_{y}—wherein y is from 0 to 3; and
each R6 is independently selected from the group consisting of hydrogen, hydroxyl, C₁₋₄-alkoxy and C₁₋₄-alkyl
(B) the N4py-type ligand is a ligand of Formula (II) 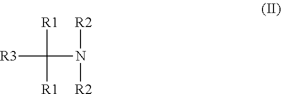
wherein:
each R1 and R2 independently represents —R4—R5;
R3 represents hydrogen, C₁₋₈-alkyl, aryl selected from homoaromatic compounds having a molecular weight under 300, or C₇₋₄₀-arylalkyl, or —R4—R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl
(C) the TACN-type ligand is a ligand of Formula (III) 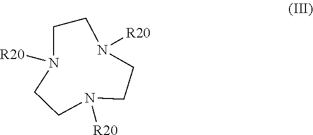
wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraaza-cyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺ (R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl,
wherein the heteroaryl may be connected to the compound via any atom in the ring of the selected heteroaryl; and
wherein at least one of R20 is a —CY₂—R22
(D) the cyclam or cross-bridged ligand is a ligand of Formula (IV) 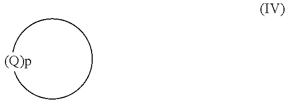
wherein
Q is independently selected from 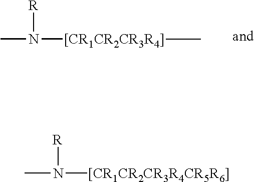
p is 4;
R is independently selected from: hydrogen, C₁₋₆-alkyl, CH₂CH₂OH, pyridin-2-ylmethyl, and CH₂COOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy, and
(E) the cross-bridged ligand is a ligand of the formula (V): 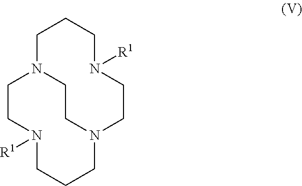
wherein
R¹ is independently selected from H, C₁₋₂₀-alkyl, C₇₋₄₀-alkylaryl, C₂₋₆-alkenyl or C₂₋₆-alkynyl
(I) the Trispicen-type ligand is a ligand of formula (VI): wherein:
$$R 17 R 17 N - X - NR 17 R 17 , \qquad ( VI )$$
X is selected from —CH₂CH₂—, —CH₂CH₂CH₂—, —CH₂C(OH)HCH₂—;
each R17 independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraaza-cyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀-arylalkyl groups optionally substituted with a substituent selected from hydroxy, alkoxy, phenoxy, carboxylate, carboxamide, carboxylic ester, sulfonate, amine, alkylamine and N⁺ (R19)₃, wherein
R₁₉ is selected from hydrogen, C₁₋₈-alkyl, C₂₋₆-alkenyl, C₇₋₄₀-arylalkyl,
C₇₋₄₀-arylalkenyl, C₁₋₈-oxyalkyl, C₂₋₆-oxyalkenyl, C₁₋₈-aminoalkyl,
C₂₋₆-aminoalkenyl, C₁₋₈-alkyl ether, C₂₋₆-alkenyl ether, and —CY₂—R₁₈, in which each Y is independently selected from H, CH₃, C₂H₅, C₃H₇ and R₁₈ is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.

10. The coating composition of claim 9, wherein the at least one thiol or polythiol is 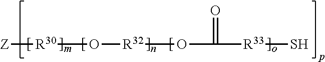
wherein
Z is a covalently bonding bridging moiety;
R³⁰ is independently selected from the group consisting of a C₁₋₃₀ branched or straight chain alkyl; C₁₋₃₀ branched or straight chain alkenyl, C₅₋₄₅-cycloalkyl, C₅₋₄₅-cycloalkenyl, C₆₋₄₅-aryl, C₆₋₄₅-arylalkyl, C₆₋₄₅-alkylaryl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, and further wherein the heteroaryl may be connected to the heteroaryl via any atom in the ring of the selected heteroaryl;
the heteroatom link being based on O, N, S, P or terminal groups based on those heteroatoms; epoxy groups; a siloxane or polysiloxane group including branched or linear equivalents, the siloxane or polysiloxane containing additional functionality such as an acrylate, unsaturated carbon-carbon bonds, alcohol or acid groups; alcohol functionality, acrylic or polyacrylic groups that may have comonomers or monomers with functionality comprising free allyl groups, unsaturated carbon-carbon-bonds or alcohol groups incorporated by use of acrylate functionality, carboxylic acid functionality or epoxy groups;
R³² and R³³ are selected from the group identified for R³⁰;
m, n, o are either 0 or 1;
p is an integral value from 1 to 10; and wherein
the siloxane or polysiloxane is linear or branched polymer or derivatized polymer with acetoxy, oxime, amine, or alkoxy substituents having a weight average (M_{w}) molecular weight of between 200-50,000 inclusive.

11. The coating composition of claim 10 wherein the at least one thiol or polythiol is selected from the group consisting of:
(F) ethylene bis(thioglycolate) 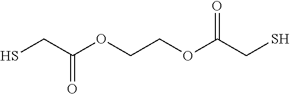 [SMILES: O=C(CS)OCCOC(=O)CS]
(G) trimethylolpropane tris(3-mercaptopropionate) 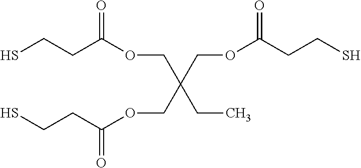 [SMILES: CCC(COC(=O)CCS)(COC(=O)CCS)COC(=O)CCS]
(H) pentaerythritol tetrakis(3-mercaptopropionate) 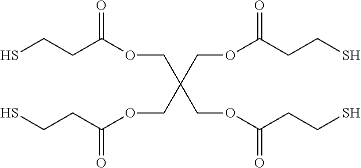 [SMILES: O=C(CCS)OCC(COC(=O)CCS)(COC(=O)CCS)COC(=O)CCS]
(I) dipentaerythritol hexakis(3-mercaptopropionate) 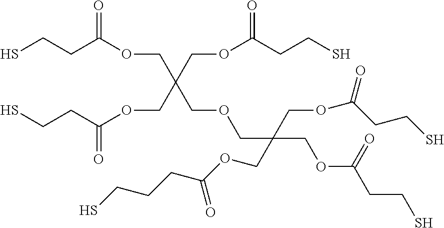 [SMILES: O=C(CCS)OCC(COCC(COC(=O)CCS)(COC(=O)CCS)COC(=O)CCCS)(COC(=O)CCS)COC(=O)CCS]
(J) a mercaptoalkionate 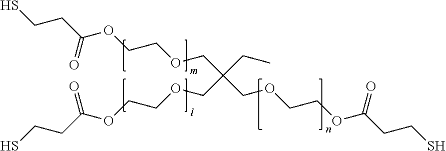
wherein the molecular weight of segments for l+m+n being adjusted so that the weight average (M_{w}) molecular weight totals to ˜500-2000 and wherein l+m+n independently total to a range between ˜10-40.
